(19) United States
(12) Patent Application Publication
(10) Pub. No.: US 2008/0081142 A1
(43) Pub. Date: Apr. 3, 2008

(54) Articles and methods for applying color on surfaces

(76) Inventors: Douglas Bruce Zeik, Liberty Township, OH (US); Chia-Hsi Chu, Arcadia, CA (US); Roger A. Fahlsing, Valparaiso, IN (US); Carol A. Koch, San Gabriel, CA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/904,941

(22) Filed: Sep. 28, 2007

Related U.S. Application Data
(60) Provisional application No. 60/849,052, filed on Oct. 3, 2006.
(60) Provisional application No. 60/849,053, filed on Oct. 3, 2006.
(60) Provisional application No. 60/934,452, filed on Jun. 13, 2007.

(51) Int. Cl. B32B 7/10; B32B 27/06

(52) U.S. Cl. 428/41.3; 428/41.6

(57) ABSTRACT

A decorative dry color laminate includes a dry color layer, a pressure-sensitive adhesive layer on one side of the dry color layer, and a carrier in releasable contact with the dry color layer on a side opposite from the pressure-sensitive adhesive (PSA). In use, the adhesive layer adheres the dry color laminate to the surface under application of pressure, and the carrier is peeled away to expose the dry color layer. Methods for providing a substantially permanent color effect on an architectural surface comprise delivering such an article to the architectural surface.

### CROSS REFERENCE TO RELATED APPLICATIONS

This application claims the benefit of U.S. Provisional Application Nos. 60/849,052 and 60/849,053, both of which were filed on Oct. 3, 2006; and U.S. Provisional Application No. 60/934,452, filed Jun. 13, 2007, which are incorporated by reference herein.

### JOINT RESEARCH AGREEMENT

Subject matter claimed in the present application was made pursuant to and as a result of activities within the scope of a joint research agreement between The Procter & Gamble Company and Avery Dennison Corporation.

### FIELD OF THE INVENTION

The present invention is directed to articles for applying color on a surface, for example an architectural surface. Methods of making such articles, and methods of applying color on a surface are also described.

### BACKGROUND OF THE INVENTION

It is often desirable to apply one or more colors to a surface, for example an architectural surface such as an interior or exterior wall or the like, for aesthetic benefits or other purposes. Color is typically provided by conventional painting with water-based or oil-based wet paints, application of wallpaper or the like. In spite of the benefits provided by applying color on a surface by wet painting or wall papering, the efforts required in connection with such procedures are inconvenient and time consuming.

Numerous attempts have been made to decorate surfaces in alternative manners. Such attempts include those described in the following patent publications: U.S. Pat. No. 4,054,697, Reed; U.S. Pat. No. 5,322,708, Eissele; U.S. Pat. No. 5,413,829, Brown, et al.; U.S. Pat. No. 6,703,089, DeProspero, et al.; EP Patent 0 569 921, Smith; and, PCT Publication WO 94/03337.

The search for improved articles for applying color on a surface, methods of making such articles, and methods of applying color on a surface has, however, continued. In particular, it may be desirable for such articles to have a virtually seamless and paint-like appearance.

### SUMMARY OF THE INVENTION

The present invention is directed to articles for applying color on a surface, for example an architectural surface. Methods of making such articles, and methods of applying color on a surface are also described. There are numerous non-limiting embodiments of the present invention.

In one aspect, the invention is directed to articles for applying color on a surface. In one non-limiting embodiment, the invention is directed to a multi-layer laminate for providing a layer of color to a substrate surface. The laminate includes a dry color layer and a pressure-sensitive adhesive layer for adhering the laminate to the substrate surface. In one version, the color layer is a decorative dry paint layer. In this version, the laminate includes a flexible structural layer between the dry color layer and the adhesive layer. The structural layer provides structural support for the dry color layer. The structural layer may optionally also serve other purposes, for example, the structural layer may also serve to provide additional opacity for the dry color layer. The structural layer may optionally also serve as a discoloration prevention barrier layer to reduce or eliminate migration of pigments or dyes (particularly azo-type pigments or dyes) in a painted substrate into the color layers of the laminate, which would cause discoloration of the color layers. The structural layer may also optionally serve as a formation web upon which the other layers of the laminate may be formed during the process of making the laminate. The laminate further optionally includes a carrier in releasable contact with the dry color layer on a side opposite from the pressure-sensitive adhesive (PSA). In use, the adhesive layer adheres the laminate to the substrate surface under application of pressure, and the carrier is peeled away to expose the dry color layer.

The multi-layer laminate can be made in a number of different manners. In one non-limiting embodiment, the laminate is made by initially using the structural layer as a formation web upon which the other layers of the laminate may be formed. The structural layer can, for instance, have layers formed thereon in the following order: one or more optional opacifying layers, one or more color layers, one or more optional patterns or print coats, and one or more topcoats. The carrier can be formed separately with an adhesive release coat on one side (for engaging the pressure sensitive adhesive layer when the laminate is in roll form) and a release surface on the surface that will face the topcoat. The carrier can then be releasably joined to the topcoat. The pressure sensitive adhesive layer can also be formed separately and then joined to the structural layer.

In another aspect, the invention is directed to methods for providing a substantially permanent color effect on an architectural surface. In one embodiment, the methods comprise delivering an article according to one of the embodiments described above to the architectural surface.

### BRIEF DESCRIPTION OF THE DRAWINGS

The following detailed description will be more fully understood in view of the drawings in which:

FIG. 1 is a schematic diagram showing the layers of one embodiment of an article for applying color on a surface according to the present invention;

FIG. 1A is a schematic diagram of an alternative embodiment of an article for applying color to a surface, which article comprises a dual layer adhesive;

FIG. 1B is a schematic diagram of another alternative embodiment of an article for applying color to a surface, which article comprises an opacifying layer on each side of the structural layer;

FIG. 2 is a schematic diagram of one process for producing a dry color component for use in the article; and

FIG. 3 is a schematic diagram of one embodiment of the manner in which the components of the article shown in FIG. 1 are assembled;

FIG. 4 is a perspective view of the device used in the “Bubble Test”.

FIG. 5 is an enlarged perspective view showing one example of the surface texture of a section of primed U.S. drywall material.

FIG. 6 is a further enlarged schematic cross-sectional view showing one example of an article for applying color to a surface which achieves a degree of conformability with the surface of the underlying drywall material.

FIG. 7 is an enlarged schematic cross-sectional view showing one example of an article for applying color to a surface which achieves relatively poor conformability with the surface of the underlying drywall material.

The embodiments shown in the drawings are illustrative in nature and are not intended to be limiting of the invention defined by the claims. Moreover, individual features of the drawings and the invention will be more fully apparent and understood in view of the detailed description.

### DETAILED DESCRIPTION

The present invention is directed to articles for applying color on a surface, for example an architectural surface. Methods of making such articles, and methods of applying color on a surface are also described.

Dry Color Laminate

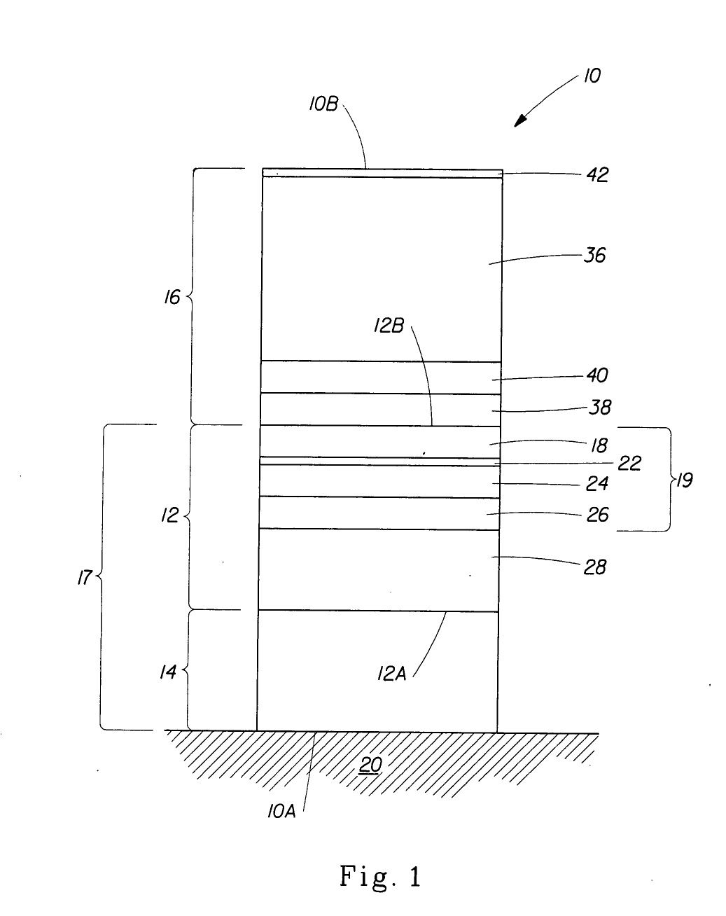

FIG. 1 shows one non-limiting embodiment of an article according to the present invention applied to a substrate surface 20. The article comprises a multi-layer dry color laminate 10, which may be in the form of a multi-layer sheet or film. It should be understood that only one layer of the laminate needs to be colored. It is not necessary that all of the layers of the laminate be colored. The dry color laminate may provide attributes of abrasion resistance, solvent resistance and opacity similar to conventional wall paints. The dry color laminate is adapted to be applied to architectural surfaces such as interior and exterior walls of buildings, building fixtures or appliances, furniture, and the like. In cases in which the dry color laminate is applied to walls, it may be referred to herein as a “wall film”. The dry color laminate may be repositionable during application, and substantially permanently adherable to the surface thereafter.

As shown in FIG. 1, the multi-layer dry color laminate 10 comprises a dry color component 12. The dry color component 12 has a first surface (or “inner surface”) 12A facing toward the surface 20 to which the dry color laminate 10 is applied, and a second surface (or “outer surface”) 12B facing away from the surface 20 to which the dry color laminate is applied. There is an adhesive 14 on, or joined to, the first surface 12A of the dry color component, and a carrier structure 16 on, or joined to, the second surface 12B of the dry color component 12. In this embodiment, the carrier structure 16 will be removed once the dry color laminate is applied to the surface 20. In other embodiments, the carrier structure 16 may be optional and omitted. The portion of the dry color laminate 10 that remains on the substrate surface 20 after removal of the carrier structure 16 will comprise the dry color/adhesive component (which may be referred to herein as the “surface covering component”), and designated by reference numeral 17.

The term “joined to”, as used in this specification, encompasses configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The term “joined to” encompasses configurations in which an element is secured to another element at selected locations, as well as configurations in which an element is completely secured to another element across the entire surface of one of the elements.

In the embodiment shown, the dry color component 12 comprises several sub-components. These comprise, from the outer surface 12B to the inner surface 12A: one or more topcoats 18; one or more patterns or print coats 22; a color coat 24 in the form of one or more layers; one or more opacifying coats or layers 26, and, a structural layer 28. Each of these has a first surface (or “outer surface”) facing away from the surface 20 to which the dry color laminate is applied, and a second surface (or “inner surface”) facing toward the surface 20 to which the dry color laminate is applied. The topcoat 18, patterns or print coats 22, color coat 24, and opacifying coats or layers 26 may be referred to herein together as the “dry color element” (or the “dry color layers” or “decorative component”) 19, although the topcoat need not be colored. The carrier structure 16 may also comprise several sub-components or elements. These may include one or more of the following: a carrier sheet 36; a first release surface, release surface or layer 38; an adhesive layer 40; and, a second release surface, adhesive release coat layer 42.

It should be understood that while the schematic diagram of FIG. 1 shows relative thicknesses of the components of the decorative dry color laminate, the illustrated thicknesses provide no limitation on actual thicknesses of the respective components in the embodiment of FIG. 1 or in any of the embodiments of the remaining figures. Additionally, while the interface between the components is shown as a clearly defined line, the actual interface between components may comprise other, different or less defined configurations.

Topcoat

The topcoat 18 may provide the dry color component 12 with one or more protective qualities of abrasion resistance, water or solvent resistance, UV protection, and toughness of conventional paint, and/or may provide recoatability over the pigmented dry color layer or layers underlying it. In one embodiment, the topcoat is a transparent or substantially transparent clear coat layer. The topcoat can also provide the dry color component with the desired level of surface gloss, or visual effects such as pearlescence, fluorescence, or the like. The topcoat adheres to the carrier structure 16, which is adapted to release from the topcoat during or after application to the substrate surface 20.

The topcoat 18 may be in any suitable form, including in the form of a layer or coating. The topcoat may comprise a single layer or coat, or multiple layers or coats. If the topcoat comprises more than one layer or coat, the different layers can be comprised of the same material, or different materials. (The same is true of the other layers of the multi-layer laminate.) The topcoat may be printed, extruded, or it may be formulated from the various solvents described herein and applied by casting or coating techniques. In one non-limiting embodiment, the topcoat is gravure printed. The thickness of the topcoat may range generally from about 0.01 to about 0.4 mil (about 0.25-10 microns (μm)), from about 0.01 to about 0.3 mil (about 0.25-8 μm), or from about 0.02-0.12 mils (0.5-3 μm). These thicknesses and all of the other thicknesses specified herein refer to dry film thicknesses.

The topcoat 18 may comprise any of the polymeric binder or resin materials described herein for use in the color layer. In one embodiment, the topcoat comprises an acrylic resinous material, such as poly (ethyl methacrylate). One suitable resin is ELVACITE® 2042 resin from the Lucite International Company. The dry color laminate 10 may be provided with desired gloss characteristics through the use of particles (for example, protruding particles) included in the topcoat 18 (that is, a “filled” topcoat), post-treatment, or texturization (embossing). In one embodiment, the dry color laminate may have a matte finish, and the topcoat can contain a dispersed filler or flattening agent such as silica to lower the gloss of the matte finish of the dry color laminate. The characteristics of the topcoat may also be altered through printing, post-treatment or texturization (embossing) specific regions of the overall surface to create differing gloss, texture, or color. These regions may further comprise a defined pattern for aesthetic purposes and/or functional purposes. The patterns may, for example, be used to hide seams when sheets of the laminate are placed on a substrate next to one another, and preferably overlapped. Patterns suitable for this purpose are described in U.S. Patent Application Publication No. US 2004/0076788 A1.

Providing the dry color laminate 10 with the desired gloss characteristics through the use of texturization (embossing) can provide the advantages of allowing greater control over the gloss characteristics. For example, the gloss may be changed by altering the pattern of an embossing cylinder instead of either reformulating the topcoat, or providing additives into the topcoat. This allows the composition of the topcoat to remain the same. Manufacturing efficiency can be improved since gloss changes can easily be achieved by changing the embossing pattern and avoiding the cleaning and changeover required for changing between different filled topcoats. The dry color laminate may also be provided with two or more regions with different glosses using techniques such as texturization.

Providing the dry color laminate 10 with the desired gloss characteristics through the use of texturization (embossing) can result in a surface topology with a dimpled/cratered surface (negative skew) rather than the protruding surface features (positive skew) as is the case for a printed flattening agent described above. Incident light is scattered from the fine surface features formed into the topcoat rather than from the features obtained from the added flattening agent. The embossed pattern can be transferred to topcoat surfaces comprised of thermoplastic materials with a combination of time, pressure, and temperature causing the surface to conform to a patterned master surface such as an embossing cylinder or belt. For topcoats produced by cured polymer systems such as UV or electron beam receptive topcoats, the embossing operation can be done by contacting the uncured topcoat surface with the desired embossing surface during the curing operation. The gloss can alternatively be changed by texturization (embossing) of the entire dry color laminate by yielding the overall structure with sufficient time, temperature and pressure (embossing conditions) to cause permanent deformation of the laminate.

Such a patterned topcoat surface is designed such that the negative impression provides the desired surface on the finished product. In one embodiment, simple patterns from blast media on metal plates can form surfaces in the embossed product with varying degrees of gloss. The degree of surface feature transfer from the embossing plate is controlled by the embossing conditions. In one embodiment, gloss levels of finished product measured by the specular reflectance of a beam of light at 85° could be manipulated from a value of 13 gloss units (matte) to a value of 30 gloss units (sheen) again by varying the size of the surface features on the embossing plates and the conditions of the embossing process.

Surface features can be embossed into the product to provide optical effects and change the tactile nature of the resulting surface. Holographic or prismatic effects are produced when a fine pattern in the surface acts to diffract the incoming light. These effects may also be combined with macroscopic patterns for aesthetic purposes and/or functional purposes such as seam hiding as described above. The surface roughness along with the coefficient of friction of the material can be varied to change the tactile feel of the product surface.

Print Coats

The one or more patterns or print coats (or “grains”) 22 comprise decorative components that may be used to provide the dry color component 12 with a design that is visible through the topcoat. The patterns 22 can be used for aesthetic purposes and/or functional purposes. The patterns may, for example, be used to hide seams when sheets of the laminate are placed on a substrate next to one another, and preferably overlapped. Patterns suitable for this purpose are described in U.S. Patent Application Publication No. US 2004/0076788 A1. Additionally, the print coat patterns may be used to build opacity of the overall dry color laminate.

The patterns or print coats 22 may comprise one or more polymeric binders or resins and one or more pigments dispersed in the binder or resin. The inks or dyes used to form the patterns 22 can be opaque, or translucent. The patterns 22 can be provided in any suitable structure, including, but not limited to layers, or in the form of printed arrays or elements. The patterns 22 can comprise areas where there is color, and areas which are devoid of color. The areas that are devoid of color will appear to be transparent, clear, or free of the pattern so that portions of the color coat 24 can be seen through the patterns 22. The areas that are devoid of color may be larger in total than the areas where there is color. In other embodiments, the opposite relationship may be present.

There can be any suitable number of patterns or print coats 22, including 1, 2, 3, 4, 5, etc. In one non-limiting embodiment, the patterns 22 comprise two or more printed arrays, one of which is printed on top of the other. In one version of such a dry color component, the two patterns are each in the form of a printed array, one printed array is printed with blue or gray ink, and the other is printed with brown or tan ink. In one embodiment, the patterns 22 may be very thin, such as less than or equal to about 1 μm in thickness, and in some cases, less than or equal to about 0.5 μm.

Color Layer

The color layer 24 can comprise any suitable element or structure that provides the dry color laminate with color. The color layer may, for example, comprise inks, paints, colored films, metalized films, opacified films, pigmented adhesives, lacquers, solid pigments, planchettes (suspended textile or cellulose fibers), or any other structure or element that provides the dry color laminate with color. In other embodiments, however, the color layer and/or the dry color laminate may be substantially free of textile or cellulose.

In one non-limiting embodiment, the color layer comprises a paint, and more specifically one or more layers of dry paint. In such an embodiment, the color layer may, therefore, also be referred to herein as a “dry paint layer”. The dry color layer may also provide at least portions of the dry color laminate with at least a degree of opacity. The dry color layer 24 should be substantially free of any liquid carriers after the formation of the dry color layer is completed. The dry color layer may be in any suitable form, including in the form of a layer or coating. The dry color layer may comprise a single layer or coating, or multiple layers or coats.

In one non-limiting embodiment, the dry color layer 24 comprises a paint composition comprising a solid coloring material, i.e., one or more pigments, suspended in a liquid medium and applied directly or indirectly to a carrier such as the structural layer 28, followed by drying to form a flexible opaque dry color film.

The dry color layer or layers 24 may comprise one or more polymeric binders or resins and one or more pigments dispersed in the binder or resin. These layers may be made from solvent cast liquid paint compositions. These compositions may be dispersed in water, or in one or more organic solvents, and optionally may contain one or more additional additives for controlling processing properties. In some embodiments, the dry color layer is essentially non-fibrous. The color layer may be formed by coating techniques such as roll coating including reverse roll coating, gravure printing including reverse gravure, flexographic, offset lithography, letterpress, silk screen, or in combinations such as flexographic/screen, letterpress/offset lithography, etc., slot die, and curtain coating. In other embodiments, the dry color layers, and/or the topcoat layer may each comprise independently one or more extruded layers, including those formed by co-extrusion and extrusion coating.

Any binder or resin conventionally used in wall paint formulations may be used in the dry color layer(s). The binder may, for example, comprise a thermoplastic or thermosetting resin. Examples of useful binders or resins generally include synthetic latex resins, acrylic, vinyl, polyester, alkyd, butadiene, styrene, urethane, cellulosic, and epoxy resins and mixtures thereof. For example, the binder or resin may include one or more polystyrenes; polyolefins, including polyethylenes and polypropylenes; polyamides; polyesters; polycarbonates; polyvinylidene fluoride; polyvinyl chloride (PVC); polyvinyl alcohol; polyethylene vinyl alcohol; polyurethanes, including aliphatic and aromatic polyurethanes; polyacrylates; polyvinyl acetates; ionomer resins, cellulosic polymers, and mixtures thereof. In certain embodiments, however, it may be desirable for the dry color layers, or even the entire multi-layer laminate 10 to be substantially free of polyvinyl chloride.

The pigment may be any pigment used in making decorative coatings. These include opacifying pigments, such as titanium dioxide and zinc oxide, as well as tinting pigments known in the art. Filler pigments, such as clay, silica, talc, calcium carbonate, kaolin clay and mica, can be added as well in conventional amounts traditionally used in coating and paint formulations.

The solvent may be one or more organic-based solvents or water, or a water-based solution may be used to form an aqueous emulsion with the binder or resin. Water-based solutions include water-alcohol mixtures. In other embodiments, the dry color layer(s) can be made from solvent-free coatings (eg., UV curable coatings) for ease of processing.

Additional ingredients that may be used include wetting agents; plasticizers; suspension aids; coalescing agents, surfactants, thickeners, thixotropic agents such as silica; water repellant additives such as polysiloxane compounds; fire retardant additives; biocides; bactericides; defoamers; and flow agents. In certain embodiments, however, it may be desirable for the dry color layers, or even the entire multi-layer laminate to be substantially free of plasticizers.

By way of example, the pigment concentration for certain embodiments of the liquid paint or coating composition used to form the dry color layers may range from about 0.4% to about 38% by weight, or alternatively from about 13% to about 27% by weight when applied by gravure printing. The binder or resin concentration may range from about 12% to about 40% by weight, or from about 22% to about 37% by weight. The water or organic solvent concentration may range from about 30% to about 85% by weight for gravure, or from about 40% to about 60% by weight. Additional ingredients such as wetting agents, suspension agents, etc., may have concentrations up to about 5% by weight. The coating or paint compositions used in making the dry color layers may have a pigment volume concentration (pigment volume divided by total volume of non volatile components) from about 9% to about 16%.

The color layer(s) may have a combined thickness in any suitable range, including but not limited to the following ranges: from about 0.05 to about 0.5 mils (about 1.2-13 μm); from about 0.05 to about 0.3 mils (or less than about 0.3 mils) (about 1.2-8 μm), from about 0.06 to about 0.2 mil (about 1.5-5 μm), and from about 0.08 mil to about 0.16 mil (about 2-4 μm).

Opacity Layers

The dry color laminate may have one or more opacifying or opacity layers 26 underlying the dry color layer(s). The opacity layers may be in any suitable form including in the form or layers or coatings. The opacity layers may comprise one or more polymeric binders or resins and one or more pigments dispersed in the binder or resin. The opacity layers may, for example, comprise white ink layers containing TiO₂, metalized films, filled films, or other structures that provide the dry color laminate with additional opacity. Metalized film opacity layers may, for example, be formed by depositing an evaporative metal on the structural layer.

The opacity layers may be in any suitable location, including on either or both sides of the structural layer 28. In one non-limiting embodiment, the opacity layers comprise one or more white ink layers on the side of the structural layer closest to the topcoat. In another embodiment, the opacity layers comprise one or more white ink layers on each side of the structural layer. FIG. 1B shows an example of a dry color laminate having a structural layer with opacity layers printed on both surfaces of the structural layer. The opacity layers may be tinted or colored similarly to the value or hue of the color layers to minimize the color difference between the overlying color layers to minimize seam appearance. This will minimize the visibility of the edges on the multi-layer laminate.

The opacity layer(s) may have a combined thickness in any suitable range, including but not limited to the following ranges: from about 0.05 to about 0.5 mils (about 1.2-13 μm); from about 0.05 to about 0.3 mils (or less than about 0.3 mils) (about 1.2-8 μm), and from about 0.06 to about 0.3 mil (about 1.5-8 μm). In the case of metalized film opacifying layers, the opacifying layer may be thinner, for example, as low as 100-300 Angstroms (10-30 nanometers or 0.01-0.03 microns).

Structural Layer

The structural layer (or “support layer” or “reinforcing layer”) 28 provides structural support for the dry color layer(s). The structural layer can optionally also serve other purposes, such as to provide additional opacity for the dry color layer and/or serve as a discoloration prevention barrier layer. In the latter case, the structural layer may serve as a barrier to reduce or eliminate migration of pigments or dyes (particularly azo-type pigments or dyes) in a painted substrate into the color layers of the laminate, which would cause discoloration of the color layers. The structural layer may also serve as a formation web upon which the other layers of the laminate may be formed during the process of making the laminate. The structural layer may have a tensile strength which exceeds that of the dry color layer or layers.

The structural layer can comprise any suitable material that is capable of permitting the structural layer to serve one or more of the functions specified above for the structural layer. Suitable materials for the structural layer include, but are not limited to films made of polypropylene, polyethylene (including LDPE and HDPE), polyester, polyethylene terephthalate (PET), polyamides (e.g., nylon), polystyrene, polyurethane, and ethylene vinyl alcohol (EVOH), as well as metalized films. In certain embodiments, the structural layer may comprise a pre-formed self-supporting polymeric film (that is, a film which is not formed in situ, for example, as a coating, during the process of making the laminate). More particularly, the structural layer may be a pre-formed axially-oriented, semi-crystalline polymeric film. In certain embodiments in which it is desirable for the structural layer to provide discoloration barrier benefits, the structural layer may comprise a film selected from the group consisting of polyester, polyethylene terephthalate (PET), and polyamides.

In some cases, the structural layer may contain one or more of the above-described pigments to enhance opacity of the finished laminate. The concentration of pigment in the structural layer, when used, may be in any suitable range, including up to about 40% by weight, and from about 6 to about 10% by weight. The structural layer may alternatively, or additionally have one or more opacity layers printed on either, or both of its surfaces as described above. In addition, if the structural layer is also used to provide the laminate with opacity, this can allow the amount of pigment in the dry color layer(s) to be reduced.

The dry color layers, outer topcoat layer or structural layer independently may contain inorganic fillers or other organic or inorganic additives to provide desired properties such as appearance properties (clear, opaque or colored films), durability and processing characteristics. Examples of useful materials include calcium carbonate, titanium dioxide, metal particles, fibers, flame retardants, antioxidant compounds, heat stabilizers, light stabilizers, ultraviolet light stabilizers, antiblocking agents, processing aids, and acid acceptors.

One or more of the dry color layers, opacity layers, outer topcoat layer or structural layer may contain a minor amount of an adhesive resin to enhance the adhesion thereof to adjacent layers. Also, or alternatively, tie coat layers of an adhesive resin can be used between any of the layers described herein. The adhesive resin for the tie coat can be an acrylic resin adhesive, or it can be an ethylene/vinyl acetate copolymer adhesive such as those available from DuPont under the tradename ELVAX™. The adhesive resins available from DuPont under the tradename BYNEL™ also may be used.

In certain embodiments, it may be desirable for the structural layer 28 to be flexible, and to exhibit at least a minimal level of extensibility, but to be substantially non-elastic (substantially non-elastomeric) at room temperature under those forces acting on it during application of the laminate to the substrate surface. In other embodiments, the structural layer 28 may be substantially inextensible or non-stretchable. The decorative dry color laminate may be provided with other properties so that it is capable of conforming closely to very small textures of substrate surfaces, even when the structural layer is substantially inextensible. In some embodiments, at least some of the other components of the multi-layer laminate (the dry color layers, the opacity layer(s), and the outer topcoat layer, may also be flexible, but substantially inextensible and non-elastic at room temperature. In other embodiments, one or more of these components may be extensible, at least when such components are not joined directly or indirectly to an inextensible structural layer.

The structural layer 28 may be thicker than the print coats, the dry color layer(s) and/or the opacity layer(s). This may allow the structural layer to be the component of the laminate that is primarily responsible for providing the laminate with structural integrity. The structural layer may have a thickness in any suitable range. The thickness of the structural layer may fall within a range that includes but is not limited to the following ranges: from about 0.1 to 1 mil (2.5 to 25 microns); from about 0.1 to 0.5 mil (2.5 to 13 microns), or to about 15 microns; from about 0.23 to about 0.48 mils (about 6-12 μm); from about 4.5 and about 12 microns (0.18-0.47 mil); from about 0.3 to about 0.35 mils (about 8-9 μm); and in one case is about 0.35 mils (9 μm) thick.

When the structural layer is used, the thicknesses of the dry color component 12 (that is, the combined thickness of the topcoat, the optional print coats, the color layer(s), opacity layer(s), and the structural layer) may be in any suitable range, including but not limited to the following ranges: from about 0.25 to about 1.5 mils (about 5-38 μm); from about 0.25 to about 1 mils (about 5-25 μm); or, from about 0.5-1 mils (about 13-25 μm).

Adhesive

The adhesive bonds the decorative laminate to a substrate surface under applied pressure, at room temperature. As used herein, the term “room temperature” refers to temperatures of from about 40° F. (4° C.) to less than 104° F. (40° C.), and includes any narrower range within that range. The adhesive may be in any suitable form, including but not limited to layers, coatings, and regular or irregular patterns of adhesive.

The adhesive may comprise any suitable adhesive including, but not limited to: pressure sensitive; water-based; water-borne; solvent based; ultraviolet and e-beam cured adhesives; hot melt pressure sensitive adhesives; water-based pressure sensitive adhesives; water-borne pressure sensitive adhesives; static adhesives; electrostatic adhesives; and combinations thereof. It is desirable for the adhesive to be substantially non-flowable so that the adhesive has little to no edge ooze when applied to the substrate surface.

In one embodiment, the adhesive comprises a dry adhesive layer comprising a pressure-sensitive adhesive (PSA). In one variation of such an embodiment, the adhesive layer is a repositionable adhesive, having a low initial tack that allows slight movement of the laminate to allow positioning adjustments prior to forming a more permanent bond. The adhesive may have a suppressed initial level of tack at room temperature that allows the laminate to adhere to a substrate surface and be repositioned thereon. The laminate is then typically smoothed or burnished, and this is followed by removal of the carrier structure from the dry color component. The adhesive may increase in its adhesion to the substrate surface as a result of application pressure and/or undergo a subsequent buildup of adhesion due to the passage of time sufficient to permanently bond the dry color component to the substrate surface.

In some embodiments, the pressure-sensitive adhesive comprises a cross-linked acrylic resinous material, and more particularly, a cross-linked acrylic emulsion. A particularly useful adhesive material comprises an internally cross-linked acrylic emulsion. High molecular weight acrylic adhesives and externally cross-linked acrylic adhesives also may be used to produce the desired combination of functional properties. Examples of useful PSAs in which the level of crosslinking can be appropriately adjusted include acrylic emulsion PSAs such as pure polymer (butyl acrylate or 2-ethyl hexyl acrylate or 2-ethyl hexyl acrylate/butyl acrylate) PSAs or similar pigmented polymer and copolymer materials. A particularly useful PSA is an internally cross-linked acrylic emulsion PSA such as a non-tackified cross-linked copolymer emulsion of butyl acrylate and 2-ethyl hexyl acrylate. This adhesive is available from Avery Dennison Corporation as product no. S-3506.

The adhesive layer also may contain one or more pigments to enhance the opacity of the color layers overlying it and permit use of thinner color layers to achieve desired levels of opacity. Any of the pigments identified above may be used. Examples include titanium dioxide and carbon black. The pigment volume concentration may be in any suitable range, including but not limited to the following ranges: up to about 10%; from about 5% to about 10%; or, from about 2% to about 8%. A pigmented form of product no. S-3506 PSA comprises 96.8% S-3506 adhesive resin, 2.87% Rohm and Haas UCD 1106E™ titanium dioxide pigment concentrate dispersion, and 0.33% UCD 1507E™ carbon black pigment concentrate dispersion, and is gray in color.

In the embodiment shown in FIG. 1A, the adhesive comprises a two layer (or two portion) structure comprising a first layer or portion of white adhesive 32 joined to an underlying second layer or portion of adhesive 34. The second layer of adhesive can be an unpigmented adhesive, or a layer of pigmented adhesive, such as the gray colored adhesive described above. The white adhesive layer is positioned between the structural layer and the second layer of adhesive. The layer of white adhesive may be used to increase the brightness of lighter colors when lighter colors are used in the overlying patterns and dry color layer by providing a white background beneath the color layers. The layer of gray adhesive provides the two layer adhesive structure with the desired repositionability and better adherence to the surface of the substrate than the white layer could alone (that is, it has a higher adhesion to the substrate surface than the white layer). A two layer adhesive structure is used because the levels of TiO₂ required to provide the layer of white adhesive with the opacity needed to avoid the underlying adhesive or surface showing through will not have sufficient adhesion to the substrate surface. In one non-limiting embodiment, the gray adhesive layer is a form of product no. S-3506 PSA described above which is compounded with 4% by dry weight of 92%/8% TiO₂/carbon black dispersions, and the white adhesive layer comprises a form of product no. S-3506 PSA described above which is compounded with 35%, by dry weight, of a TiO₂ dispersion.

The white adhesive layer 32, which may also be referred to as an opacifying adhesive layer, together with the gray colored adhesive layer 34, which may also be referred to as a substrate adhesive layer, may provide in excess of 50% of the opacity index of the total surface covering component 17. In one embodiment, the opacifying adhesive layer 32 alone can provide greater than 50% of the opacity index of the surface covering component.

In certain embodiments, it may be desirable to produce a substantial amount of the surface covering component's opacity in the relatively higher pigment content of the opacifying adhesive layer 32, so as to reduce the amount of light colored coatings needed in the color coat layers and still achieve complete opacity (an opacity index of greater than 99%) in the surface covering component. In one embodiment, the opacifying adhesive layer 32 produces from about 70% to about 90% of the total surface covering component opacity when containing from about 10% to about 40% solids by weight of the total resin/filler solids contained in the opacifying adhesive layer.

In one embodiment comprising the layer of gray colored adhesive 34 (used for surface covering components containing dark colored dry color layers), the gray colored pressure-sensitive adhesive layer provides greater than about 50% total opacity index for the surface covering component.

In certain embodiments, the adhesive may be such that the laminate may be repositioned by sliding the laminate relative to the surface of the substrate as opposed to peeling, removing, and replacing the laminate on the substrate.

The thickness of the adhesive layer, or the combined thickness of the adhesive layers if there is more than one layer, may be in any suitable range, including but not limited to the following ranges: from about 0.4 to about 1 mil (about 10-25 μm); or, from about 0.4 to about 0.8 mil (about 10-20 μm).

Carrier Structure

The carrier structure 16 provides structural integrity to the dry color laminate until the temporary carrier is removed upon application of the dry color laminate 10 to a substrate surface 20. The carrier structure 16 may comprise a single component or element. In certain embodiments, however, the carrier structure 16 can comprise several sub-components or elements. These may include one or more of the following: a carrier sheet or “carrier” 36; a first release surface, release surface or layer 38; an optional adhesion layer such as an adhesive layer (e.g., “carrier adhesive layer”) or a tie (or primer) layer 40; and, a second release surface, adhesive release coat layer 42.

The carrier sheet 36 may comprise any material suitable for this purpose including, but not limited to paper, and polymeric films such as films made of polypropylene, polyethylene (including LDPE and HDPE), polyethylene terephthalate (PET), polystyrene, polyurethane, and ethylene vinyl alcohol (EVOH), and combinations thereof. The carrier sheet may be formed from a thin, flexible, foldable, heat-resistant, substantially inelastic, self-supporting temporary carrier film or casting sheet. In certain embodiments, for example, the carrier sheet is an oriented polyester film such as polyethylene terephthalate (PET) available as MYLAR®, a trademark of DuPont, or Mitsubishi HOSTAPHAN 2000™ polyester film.

The thickness of the carrier sheet 36 may be in any suitable range, including but not limited to the following ranges: from about 0.5 to about 2 mils (about 13-50 μm); from about 0.5 to about 1.5 mils (about 13-38 μm); or, from about 0.6 to about 1.2 mils (about 15-30 μm). In certain embodiments, the thickness of the overall carrier structure 16 may also fall within the above ranges. Providing a thin carrier sheet 36 (less than 1 mil (about 25 μm)) allows the dry color laminate to be more easily be burnished, or smoothed during application, and to achieve the desired microconformability with the surface of the substrate.

The carrier sheet 36 has a release surface or layer (or “releasable coating”) 38 on the surface facing the topcoat 18. The release surface 38 may comprise any structure which releasably adheres to the topcoat, but does not dissolve the topcoat. The level of adhesion should be sufficient to prevent separation of the release surface 38 from the topcoat 18 during the process of forming the multi-layer laminate and during normal handling, including forming the multi-layer laminate in its self-wound orientation, unwinding it, and applying it to the substrate surface. The release surface 38, however, should have sufficient release properties to facilitate separation from the topcoat after applying the surface covering component to the substrate. In addition, it is desirable that the peel force between the release surface and topcoat does not increase or decrease substantially during storage as this can adversely impact the application experience by either delamination or excessive force needed to remove the carrier film. The release surface 38 should also preferably leave a minimum amount of residue, and more preferably, no residue on the topcoat surface. Several non-limiting examples of release surface systems are described herein.

In one embodiment, a multiple layer (e.g., a dual layer) release system is used for laminating the releasable carrier structure 16 to the topcoat surface and for controlling separation of the releasable carrier structure from the topcoat during use. The dual layer release system comprises a release layer 38 that produces a controlled release from the topcoat 18 when the releasable carrier structure 16 is removed from the topcoat during use. The dual layer release system also includes an adhesion layer such as a permanent adhesive layer or “carrier adhesive” 40. The adhesion layer may comprise a permanent pressure sensitive adhesive bonded to the carrier sheet 36. The permanent adhesive 40 may be initially laminated to the release layer 38 which has been coated on the dry color component 12. The release layer 38 may comprise a material that initially adheres to the topcoat 18 during drying, but by its tack-free condition will separate cleanly without affecting gloss and release from the topcoat when the releasable carrier structure 16 is peeled away from the topcoat 18 since it is bonded to the permanent adhesive layer 40 on the releasable carrier sheet 36. This release system allows the desired peel force to be selected, and the force will preferably be stable throughout storage and application.

It should be understood that the general references herein to the releasable carrier structure separating from the topcoat are for simplicity of discussion only. This description is intended to cover multi-layer laminate structures in which the releasable carrier structure 16 is releasably joined to not only the topcoat, but also structures in which there is no topcoat and the releasable carrier structure 16 is releasably joined to either the outermost pattern layer, or to the dry color layer.

In this embodiment, the release layer 38 comprises a coating of a polar, preferably a highly polar release material which in dry film form is tack-free at room temperature. This coating may be coated or printed on the topcoat, and dried. The release layer material 38 has a difference in polarity, preferably a substantial difference in polarity from that of the outer surface of the topcoat or dry color component 12. In one embodiment, the release layer material comprises a polar (hydrophilic) material, or a highly polar material, and the topcoat material is non-polar, or has a lower polarity. The topcoat may comprise a material of sufficiently low polarity which is unaffected by exposure to humidity or water (hydrophobic). In other embodiments, the release layer 38 may be apolar relative to the topcoat. The release layer 38 material may be made from a highly polar material such as a polymeric material which is dissolvable in a water/alcohol solution. In one version of such an embodiment, the release layer material 38 comprises a copolymer of hydroxyethylmethacrylate (HEMA) and hydroxybutylacrylate (HBA) polymerized in water and ethanol. The release layer material can be the hydrophilic or highly polar homopolymers or copolymers prepared by the methods described in U.S. Pat. No. 6,653,427 to Holguin.

The difference in polarity has to do with the relative solubility of the solvent or volatiles in the release coat materials which are coated on the top coat. The polymers which comprise the release coat material are dissolvable in a solvent which does not solubilize the top coat material, i.e., the top coat material is insoluble in the solvent for the release coat material. As a result, and in addition to their mutual adhesion, the release coat and top coat are separable along an interface which results in an absence of any significant effect on surface properties or gloss on the exposed surface of the top coat.

Alternately, the release coat 38 material may comprise a solventless resinous material which may be coated on the top coat, or on the carrier structure 16, such as by extrusion techniques. In this instance, the two materials adhere to each other along the interface between them and separation of the release layer 38 from the top coat 18 results in no interaction or undesired effect on surface properties such as gloss of the exposed top coat surface.

The release layer 38 may be die coated or printed, by gravure printing for example, to produce a dry film thickness below about 10 microns, or below about 8 microns, and even below about 5 microns. Die coating or gravure printing of the release layer to a dry film thickness of about 5 microns or less (for example, down to a thickness of greater than about 1 micron) can provide good release or peel force levels without delamination, as described herein.

In some embodiments, the adhesion layer 40 can comprise an adhesive. In one embodiment, the adhesion layer 40 is a permanent adhesive comprising a pressure sensitive adhesive, such as that available under the designation S-8860 from Avery Dennison Corporation. The permanent adhesive material is preferably coated or printed on the carrier sheet 36 and dried on the carrier sheet 36 to form a permanent bond. The permanent adhesive is applied to the carrier sheet 36 at a dry film thickness of preferably less than about 10 microns, more preferably less than about 8 microns, and even more preferably less than about 5 microns (e.g., down to a thickness of greater than about 3 microns). The permanent adhesive layer 40 has a level of tack greater than the adhesion between the release layer 38 and the topcoat 18. The adhesion between the release layer 38 and the topcoat 18 is less than the adhesion of the surface covering component 17 to the substrate surface 20.

During processing, after the dry color layer 24 is formed on the structural layer 28, the resulting composite film then can be transported to a laminating station where the permanent PSA-coated side 40 of the releasable carrier 16 is laminated to the dry release layer 38 which has been coated on the top coat surface 18. This forms a permanent bond between the permanent PSA 40 and the release layer 38.

The release layer 38 enables the carrier structure 16 to be removed easily from the topcoat surface 18 with a desired release or peel force and produces a stable removal force over time at elevated room temperatures and pressures. In one embodiment, the release layer 38 has a Tg above about 35° C., and more preferably above about 40° C. In use, the release layer 38 provides a useful combination of: (1) adherence to the topcoat to avoid undesired premature delamination, (2) tack-free contact with the topcoat that avoids an undesired effect on surface gloss, (3) a sufficiently high initiation force to avoid undesired delamination from the topcoat surface, (4) a sufficiently low removal force to allow removal of the carrier at high or low speeds, and (5) a peel force level sufficiently lower than the PSA bond between the surface covering component and the substrate surface to prevent undesired removal of the surface covering component.

A release force lower than about 100 gm/2 inches (or per 5 cm) provides a good combination of such release force properties. The desired levels of release force can be achieved with different types of topcoat surfaces, namely, those that produce a low gloss matte finish, either by transfer of low gloss to the topcoat from a matte release carrier, or by use of particulate flattening agents contained in the topcoat material as described herein.

During use, the user can apply the multi-layer dry color laminate 10 to the substrate surface 20 by burnishing the multi-layer dry color laminate and then removing the releasable carrier structure 16. The rate of removal of the carrier structure 16 can vary among users. In some embodiments, it is desirable for the release layer 38 to produce effective low release forces for both low and high rates at which the carrier structure 16 is removed. The rate dependence of such a release layer is opposite that of removable PSAs which show a much higher release force at a higher rate of removal.

The release coat 38 material may have a relatively high initial release force compared to peel force during use. The high initial release force is desirable to prevent premature delamination. Because the release coat layer 38 has been coated on the topcoat 18 by solvent coating during processing, in the absence of PSA contact, the contact efficiency is high, which in turn produces the high initial release force.

Examples of release layer materials 38 having good stability of release force include a polar copolymer such as HEMA/HBA copolymer in proportions of 70/30 parts by weight, respectively; HEMA/HBA copolymer 65/35 parts by weight, respectively; and Copolymer 845™, PVP/DMAEMA, (polyvinyl pyrolidone/dimethyl amino ethyl methacrylate) a product of International Specialty Products of Wayne, N.J., U.S.A.), for example. Alternatively, an emulsion-type release material such as a polyvinyl acetate emulsion can be used.

In another embodiment, the release coating 38 is a polymer coating with a low melting point that can be heat laminated to the dry color component 12 instead of the use of a poly-HEMA coating and adhesive lamination. The polymer coating is applied to the carrier sheet 36 and subsequently heat laminated to the dry color component 12. Alternatively, this polymer coating can be used to extrusion laminate the carrier sheet to the dry color component where the heat from the processing of the polymer coating maintains the fluid nature of the polymer until lamination contact is made between the two substrates. The bond strength of the polymer release coating to the carrier sheet 36 must be sufficient to prevent delamination when the carrier sheet is removed after applying the surface covering component to the substrate. Analogous to the use of an adhesive lamination for the poly-HEMA coating system, a tie layer can replace the carrier adhesive layer 40 to provide this required bond to the carrier sheet. In such an embodiment, the tie layer may either be adhesion primer coated onto the carrier sheet 36 (for example, onto the non-silicone side of a PET release liner), or the tie layer resin may be coextrusion-coated with the polymer release coating onto the carrier sheet 36. The carrier sheet may also have a surface treatment (chemical or energy) to improve the adhesive bond to the polymer coating either with or without the use of an additional tie layer.

One useful but non-limiting example of the polymer release coating is a blend of polyolefins that are formulated to control the release properties during carrier sheet removal. The blends can be comprised solely of polyolefin materials such as low density polyethylene to produce a very low polarity coating. The release force can be increased by the addition of lower melting point polyolefins, such as plastomers, to the overall blend. The melting point for low density polyethylene can range from about 100 to 125° C. The melting points for the “additives” can range from about 60-100° C. Without wishing to be bound by theory, it is believed that the lower melting point materials provide better fluid contact with the dry color component surface for a given set of lamination conditions. These low melting point polyolefins are generally softer and have lower crystallinity. The polyolefin release coating blends can also incorporate polyethylene copolymers to not only reduce the crystallinity of the blend but to increase the polarity as well. The copolymerization of ethylene monomer with polar monomers such as vinyl acetate or methyl acrylate provide various grades, based on percent comonomer, that make compatible blends with the base low density polyethylene resin. The overall polymer release coating blend composition can be adjusted to again raise the release force through the fluid contact to the dry color component surface as well as the chemical interaction in the interface with these more polar components. In other embodiments, blends of more than two components could be used. These types of polyolefin blends form a “heat-activated polymer blend” system for use as a release coating.

The carrier structure 16 is heat laminated to the dry color component 12 at a temperature of about 275° F. to 325° F. (135° C. to 163° C.) with sufficient pressure to bond the carrier structure 16 to the dry color component 12. The heat-activated polymer blend layers are typically about 0.3 to 0.7 mil (8 to 18 microns) thick, and may be about 0.5 mil (13 microns) thick. The gravure-coated polyether imide (PEI) primer layers may be less than 0.1 micron thick. Several examples of such a release coating 38 along with suitable tie layers, and method of application of the same are set out in the table below.

Heat-Activated Polymer Blend Release Coatings

| Example | Heat-Activated Polymer Blend | Tie Layer/Application Method |
|---|---|---|
| I | 2%-5% of VA (vinyl acetate) composition in a | 26% VA content EVA |
| | LLDPE/EVA blend | applied by coextrusion |
| II | LLDPE with up to 50% ethylene hexene | PEI based primer coating |
| | copolymer plastomer in a blend | applied by gravure |
| III | LDPE with up to 50% Plastomer (Ethylene | PEI based primer coating |
| | hexene copolymer) in a blend | applied by gravure |
| IV | 2-10% of MA (methyl acrylate) in a | 26% VA content EVA by |
| | LLDPE/Ethylene methyl acrylate copolymer | coextrusion |
| | blend | |

The coextruded structure in these Examples have a total thickness of about 0.5 mil and the layer thickness ratio of 1:1. The resulting carrier structure may have release force of between about 40-90 g/2 inches (or per 5 cm) at a 300 inch per minute (7.6 m per minute) test speed, and preferably a force of between about 60-70 g/2 inches under the same conditions.

The release system separates the release properties of the releasable carrier structure from gloss transfer to the dry color component. In a prior embodiment of a surface covering component containing a matte release carrier on which the different layers of the surface covering component material were cast and dried, gloss and release properties are interdependent. Those properties are separated by the release system described herein in which gloss control and color/appearance properties are controlled by the composition of the topcoat and the underlying color layers; whereas release properties are independently controlled by the present release layer, with no interactions between release from the dry color film and control of gloss in the exposed surface covering component once the carrier structure is removed.

In another embodiment, the release layer system comprises a pressure sensitive adhesive (PSA) that is coated or printed onto the carrier sheet 36 to form the overall carrier structure 16. The PSA coated surface of the carrier structure 16 is then laminated to the topcoat surface of the dry color component to complete the multilayer dry color laminate. In one embodiment, the PSA may be comprised of externally cross-linked acrylic emulsions. The functional properties including the tack of the PSA can be adjusted through the degree of cross linking and/or the coat weight of the PSA applied to the carrier sheet. Such a PSA preferably bonds to the removable carrier and contacts the topcoat material with the same level of release efficiency described above for the release coat 38.

The release force for the PSA release layer system is rate dependent and will increase with the speed of removal of the carrier sheet. This rate dependence provides for a relatively low initiation force for peel that can aid in the removal of the carrier structure 16 from the dry color component 12. The low initiation force also requires that the magnitude of this removal force be sufficient to prevent undesirable premature delamination of the carrier structure from the multi-layer laminated article before the article is completely burnished onto the substrate surface. This premature delamination can potentially occur during: the process of manufacturing the article; the application of the article to the substrate surface; or, during the burnishing of the article to the substrate surface. A release force measured at a rate of 300 inches (7.62 m) per minute for the PSA release layers when at levels of 100 grams per 2 inches (5 cm) as described above may be subject to premature delamination issues during manufacturing and handling. The release force can be raised to levels above 200 grams per 2 inches or preferably above 300 grams per 2 inches to prevent this undesirable delamination. The higher release forces make the removal of the liner more difficult at higher removal rates, but the rate sensitivity of the PSA release system enables easy low speed removal initiation to occur even with release forces measured at 300 grams per 2 inches at a rate of 300 inches per minute.

The release force for the PSA release layer system can have the tendency to increase over time as the contact between the PSA and the topcoat increases. The low initial tack (green strength) between the PSA and the dry color component may require the use of higher tack PSA formulations or delays in manufacturing for the necessary adhesion build to prevent premature delamination during the manufacturing process. One way to reduce the need for these compensating actions is to use heat lamination for bonding the PSA to the surface of the dry color component. The combination of heat and pressure during the lamination process provides better wetting of the PSA to the top coat surface with the lower tack PSA formulations and obviates the need for higher tack formulations or delays for adhesion build. The heated lamination process also provides for less change (increase) of adhesion from the PSA over time in completed rolls of the multi-layer laminate.

The carrier sheet 36 has an adhesive release coat layer 42 on the surface facing away from the dry color component 12. The adhesive release coat layer on the opposite side of the carrier sheet may comprise any release coating composition known in the art. Silicone release coating compositions may be used. To aid in burnishing or smoothing the multi-layer laminate onto the substrate surface, it may be desirable for the adhesive release coat 42 to provide sufficient surface properties to allow burnishing with tools such as squeegees or brayers without excessive slipping.

Properties

It may be desirable for the articles (that is, the multi-layer dry color laminate) 10 to be provided with certain overall properties. The articles are not required to have one or more of these properties unless such properties are included in the appended claims. These properties may be useful in providing the articles with a virtually seamless and paint-like appearance. All properties are measured at 23° C. and 50% RH.

Thinness

The portion of the dry color laminate applied to the substrate surface (i.e., the topcoat, patterns or print coats, color layer, structural layer, and adhesive), the surface covering component 17, is preferably relatively thin to minimize visible seams if adjacent surface covering components are overlapped during application.

The overall thickness of the surface covering component 17 as applied to the substrate surface in its finished state (omitting the carrier) is preferably less than about 3.3 mils (about 84 μm), and may be: less than about 2.0 mils (about 50 μm), less than about 1.6 mils (about 40 μm), less than 1.3 mils. (about 33 μm), less than or equal to about 1.25 mils (about 32 μm), or even less than or equal to about 1 mil (about 25 μm). Suitable ranges of thickness of the surface covering component include but are not limited to the following ranges: from about 0.5-2 mils (from about 13-50 μm), or from about 1-2 mils (from about 25-50 μm), or from about 1 to 1.5 mils (from about 25-38 μm), or from about 1 to less than 1.3 mils (from about 25 to less than 33 μm).

The multi-layer laminate can have any suitable overall thickness. Suitable ranges of thickness of the multi-layer laminate, or any major components thereof can be obtained by adding the ranges specified for the sub-components thereof. In certain embodiments, the multi-layer laminate has a total thickness from about 50 to about 80 microns (2.0-3.2 or 3.3 mils).

The thicknesses of the major components of the multi-layer laminate (the dry color component, the adhesive, and the carrier structure) are measured using a caliper manufactured by Mitutoyo Corporation Model Id #C112CEB equipped with a point (#900032, Nelson Precision) under a confining load of 8.74 grams. The thicknesses of the individual layers can be measured from photomicrographs of cross-sections of the multi-layer laminate.

Opacity

The surface covering component may provide good opacity and coverage by application of a single sheet thereof, providing consumers with cost and time benefits. Preferably, the surface covering components exhibit an opacity index of at least about 0.95 as measured according to ASTM D2805. Typically, in such measurements, the surface covering component is carefully applied on a test surface, for example the surface of a color contrast card such as a Leneta opacity form 2A, avoiding bubbles and wrinkles. In more specific embodiments, the surface covering components exhibit an opacity index of at least about 0.98, and more specifically at least about 0.995 as measured according to ASTM D2805. Substantially complete coverage, i.e., full hide, may be obtained even over dark surfaces, stained surfaces and the like.

Extensibility, Flexibility, and Conformability

Extensibility

The surface covering component may desirably exhibit at least a minimum level of extensibility, sufficient to allow bending, rolling, or similar manipulations of the surface covering component. The level of extensibility of the surface covering component will depend on the components included therein, and in particular the type of structural layer used, as well as the rate of extension.

The surface covering component may have an extensibility that may range from greater than or equal to about 0.1%, to less than about 100% (and in some cases, not equal to 100%). The surface covering component may have an extensibility in any narrower range that is encompassed within the above range, such as from greater than or equal to about 1%, or greater than or equal to about 10% to less than or equal to about 50%.

In one embodiment, the surface covering component may have a relatively low degree of extensibility and be either substantially non-elastic, or non-elastic, at room temperature. For example, when the structural layer comprises a PET film, the surface covering component (without any removable carrier) may have an extensibility of between about 0.1% to about 5%, or from about 0.5% to about 1%. In some cases, these extensibilities may be measured at a pressure of 5 psi. (3.4458×10⁴ N/m²). When extensibility measurements are specified herein as being measured at a pressure, these measurements are made according to the “Bubble Test”, which is designed to simulate in use conditions (i.e., application pressures). Otherwise, the extensibility properties described herein are measured using a modified version of ASTM-D-638M on an Instron tensile testing machine.

The surface covering component may have a tensile strain at break measured using a Instron tensile testing machine of less than or equal to about 45%, or alternatively between about 30% to about 40%. The surface covering component may have a tensile modulus of greater than or equal to about 300, 400, 500, or 600 MPa. The surface covering component may have a tensile stress at break of greater than or equal to about 12, 15, 20, 30, 40, or 50 MPa. The extensibility properties described herein as being obtained on the Instron machine are measured using a modified version of ASTM-D-638M using an Instron Model 5542 tensile testing machine. Modifications are made to the dimensions of the samples, and to the elongation rate. The sample is a dog bone-shaped sample having a neck region (i.e., extension-focused region) with a length of 0.5 inches (1.3 cm) and a width of 0.125 inches (3.2 mm). The sample is elongated at 40% strain/second strain rate.

As described herein, micro conformability of the surface covering component refers to its ability to deliver a texture that closely conforms to an underlying paint roller type texture and is consumer preferred as it delivers a uniform, paint-like appearance. Burnishing of the laminate 10 during application to a surface is a factor in achieving good micro conformability and a uniform end appearance. Since consumers may burnish with different forces and rates, they may experience different levels of final micro conformability which would detract from the desired overall uniform, paint-like appearance. There exists a need to provide an article for applying color to a surface which is less dependent on rate and pressure of burnishing. As described herein, the multi-layer laminate may comprise such an article even though it may comprise a relatively rigid, semi-crystalline engineered thermoplastic structural layer.

The articles comprising thermoplastic film structural layers can be less strain rate dependent than previously-described articles comprising plasticized PVC films. This means that the final level of micro conformability may be achieved while being less sensitive to changes in application speed or pressure.

In certain embodiments, it may be desirable for the tensile modulus of the surface covering component to remain relatively unaffected by elongation rates ranging from 4% strain/second to 40% strain/second. For example, it may be desirable for the difference in tensile modulus at these different rates to be less than or equal to one of the following amounts: 6×, 5×, 4×, 3×, 2×, 1.5×, or 1.25×. It may be desirable for the difference in tensile strain at break at these different rates to be less than or equal to one of the following amounts: 1.5×, 1.4×, 1.3×, or 1.25×. It may be desirable for the difference in tensile stress at break at these different rates to be less than or equal to one of the following amounts: 1.5×, 1.4×, 1.3×, 1.25×, or 1.2×.

The surface covering component in certain embodiments, particularly those which have a relatively low degree of extensibility, may exhibit relatively low stress relaxation. The stress relaxation of the surface covering component herein is measured using a TA Model RSA-III rheological instrument obtained from Rheometrics Scientific, which is now owned by TA Instruments of New Castle, Del., U.S.A. The sample used is one which has any removable carrier removed therefrom. Two samples are obtained. Both samples have dimensions of 14 mm×12 mm. The first sample is taken from the article with the longer dimension measured in the direction of the longer dimension of the product, e.g., the direction a rolled product unrolls (typically the machine direction during manufacture of the product (or MD)), and the second sample is taken with the longer dimension measured perpendicular thereto (in the cross-machine direction (or CD)). This is a constant strain measurement. The sample is ramped to 1% strain in 0.1 seconds. This is followed by monitoring the stress decay for up to 5 minutes. In certain non-limiting embodiments, the paint/adhesive combination component may exhibit stress relaxation in any of the following amounts at 1% strain after 5 minutes: less than or equal to about 75%, 60%, 50%, 40%, 30%, 20%, or 10%.

The surface covering component in certain embodiments, particularly those which have a relatively low degree of extensibility, may exhibit a relatively low permanent set. Thus, the surface covering component will have a low tendency to retract. This will allow it to conform to the substrate surface and stay in conformity with the substrate surface. The permanent set of the surface covering component herein is measured according to the “Bubble Test”.

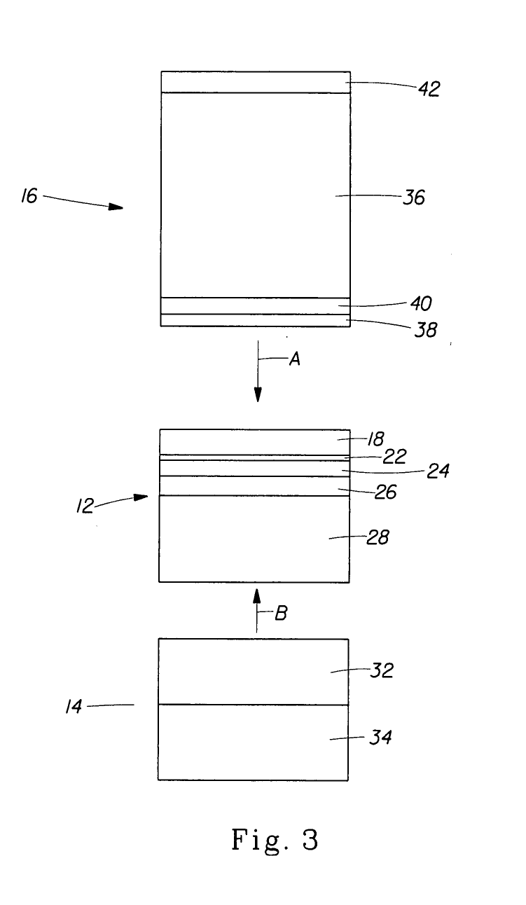

The Bubble Test is performed on a Bubble test device 50 as shown in FIG. 4. The Bubble test device has a platform 52 upon which a sample is placed, and an orifice 54 in the platform that is 0.9 inches (2.3 cm) in diameter through which pressurized air is supplied. For the Bubble Test, a sample measuring 2.5 inches×2.5 inches (6.4 cm×6.4 cm) is used. The sample has any removable carrier removed therefrom. The sample is placed on the surface of the platform 52 over the orifice. A cover 56 is placed over the sample. The cover is fastened to the platform by screws 58 that fit into four holes 60 in the platform 52. The screws are tightened to make sure device is air tight and during the measurements. There is a hole 62 in the center of the cover 56 that is ¼ inch (6.3 mm) in diameter. When pressurized air is supplied to the sample, a portion of the sample may rise up through the hole 62 in the center of the cover 56.

The Bubble Test involves subjecting a portion of the sample to air pressure from the underside in step-wise increasing amounts of 1, 2, 3, 4, and 5 psi. (6.895×10³, 1.379×10⁴, 2.069×10⁴, 2.758×10⁴, 3.4458×10⁴N/m²), and then decreasing the air pressure in step-wise amounts of 5, 4, 3, 2, 1, and 0 psi. The portion of the sample that is subjected to air pressure is 2 inches (5 cm) in diameter. The height of the top surface of the inflated bubble above the surface of the remainder of the sample is measured at each air pressure increment. The permanent set is calculated as the ratio of the bubble height after it is deflated to 0 psi. to the bubble height at 5 psi. In certain non-limiting embodiments, the surface covering component may exhibit a permanent set of greater than or equal to about 0.1% or 0.5%. In certain non-limiting embodiments, the surface covering component may exhibit a permanent set of less than or equal to about any of the following amounts: 50%, 40%, 30%, 20%, 10%, 5%, 2%, 1%, or 0.5%. In certain non-limiting embodiments, the surface covering component may exhibit a permanent set in any suitable range including, or between, the above sets of minimum and maximum values.

Flexibility

The flexibility of the articles described herein is determined by measuring their bending stiffness and rigidity.

Bending Stiffness

Bending stiffness is measured using a Testing Machine, Inc. (Ronkonkowa, N.Y., U.S.A.) bending tester model K-416. The test procedure conforms to ISO 2493. The product to be tested includes any removable carrier thereon. Two 1 inch by 1.5 inch (25 mm by 38 mm) rectangular samples are cut from the product with the 38 mm (width) cut perpendicular to the test orientation of the product, e.g., cut 38 mm in cross direction (CD) for sample testing in the machine direction (MD). One sample is placed in the bending tester with the 38 mm width oriented vertically. The tester is set so that the bending angle is 15 degrees and bending length is 5 mm. The same test run with the second sample oriented horizontally, and the values are averaged to obtain an average of bending stiffness in the machine direction (MD) and cross-machine direction (CD). The bending resistance force of the sample is measured by this instrument.

The bending stiffness of the sample can be calculated with the following equation:
Stiffness(Nmm)=8.376 10⁻⁴×Bending Resistance Force(mN)

The articles described herein may have any suitable bending resistance, such as a bending stiffness of greater than or equal to about 10 milli Newton (mN), and less than or equal to about 20 mN, 25 mN, 30 mN, 35 mN, 40 mN, 45 mN, or 50 mN. In certain embodiments, for example, the articles may have a bending stiffness of between about 10-20 mN, alternatively about 15-20 mN.

Rigidity

Rigidity is measured using a Thwing-Albert Handle-O-Meter available from Thwing-Albert Instrument Company, West Berlin, N.J., U.S.A. The test is performed according to ASTM D6828-02. A 2 inch by 2 inch (5 cm by 5 cm) square sample is cut from the product. Samples can be tested both with, and without any carrier on the same.

The articles described herein may have any suitable rigidity. For good conformity, it may be desired for the articles to have a rigidity without any carrier of less than or equal to about 1 g/cm, or less than or equal to about 0.8 g/cm (for example, from about 0.1 to about 1 g/cm, alternatively from about 0.3 to about 0.7 g/cm). The articles may have a rigidity with a carrier of less than or equal to about 20 g/cm, 15 g/cm, or 13 g/cm (for example, from about 4 to about 13 g/cm, or alternatively, less than or equal to about 10 g/cm). In some embodiments, the rigidity with the carrier may be greater than about 4 g/cm.

Conformability

The surface covering component may also exhibit sufficient conformability to adapt to the topography/surface morphology of the surface to be colored. In addition, the surface covering component may be sufficiently conformable to allow the articles to be easily manipulated around and/or into corners and other three-dimensional configurations. Further, the sheet of the surface covering component may be micro-conformable. As used herein, micro-conformability refers to the ability of the articles to become similar in form or character to the surface to which they are adhered, whereby, upon application, both inner and outer surfaces, 17A and 17B, respectively, of the surface covering component will mimic the texture of the underlying surface to provide a paint-like appearance.

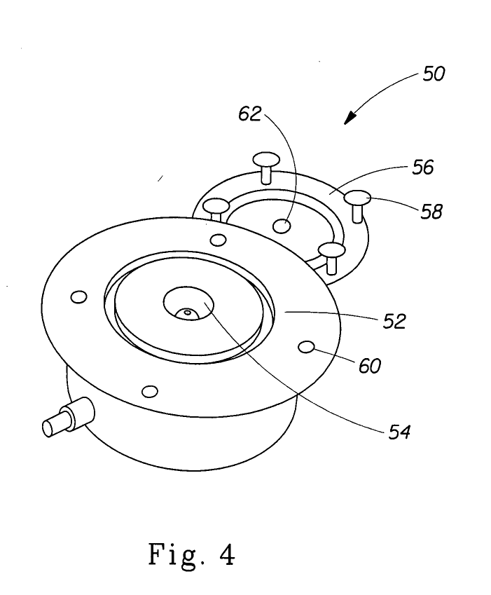

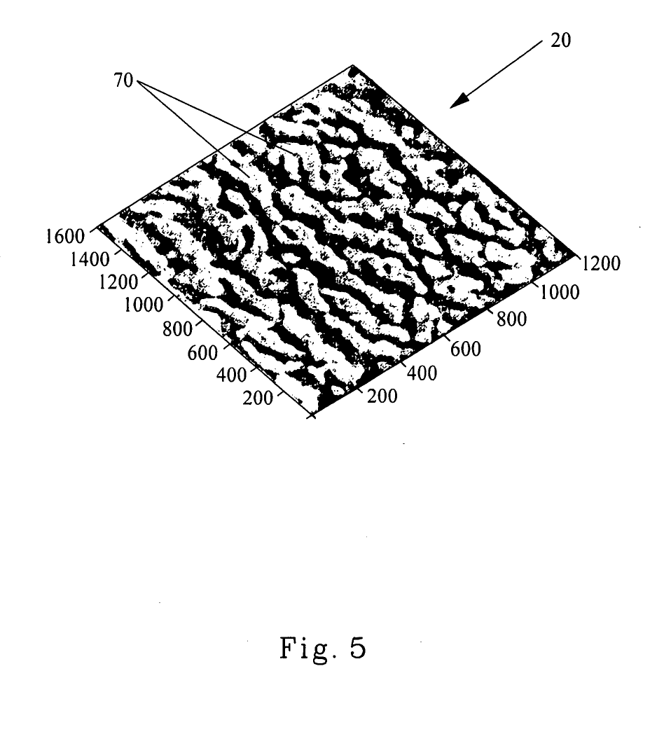

Specifically, in the case of application to interior walls, it has been found desirable for the surface covering component 17 to be sufficiently conformable to conform to the texture left by a paint roller in applying paint or primer to an underlying surface, for example drywall. Drywall is used as an example of a typical surface but is not intended to limit potential suitable surfaces. FIG. 5 shows one example (enlarged) of the surface texture of a section of primed and painted U.S. drywall material 20. As shown in FIG. 5, the surface of drywall has a plurality of irregular rugosities 70 thereon. These are shown in schematic cross-section in FIG. 6. As shown in FIG. 6, the surface of the drywall 20 comprises the rugosities 70 (three of which are shown), which may be considered to define the visible, or “macro” surface roughness of the painted drywall. FIG. 6 also shows that each of these rugosities has micro-rugosities 72 thereon (which can only be seen under magnification). The micro-rugosities 72 may be considered to define the micro roughness of the surface 20.

FIG. 6 shows an example of the outer surface 17B of a surface covering component 17 that deflects to achieve a degree of micro-conformability with the surface 20 of the painted drywall material. The term “micro-conformability”, as used herein, refers to at least partial conformability to the visible rugosities 70 as opposed to bending around corners, and the like (which relates to “conformability”); it does not require conformability to the micro-roughness 72 of the surface.

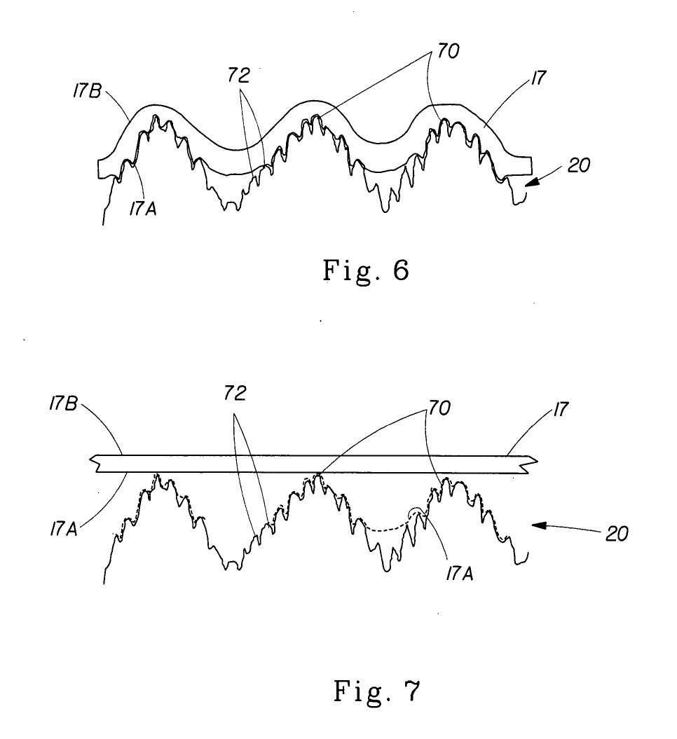

As shown in FIG. 6, it is not only desirable that the inner surface 17A of the dry color component 17 at least partially conform to the texture of the underlying surface 20 to which the dry color laminate is adhered, it is also desirable that the outer surface 17B also at least partially conform to (or follow) the texture of the underlying surface 20. As shown in FIG. 6, perfect conformity to the texture of the underlying surface is not necessary, however. Thus, it is not necessary that the inner surface 17A of the dry color component 17 conform exactly to the rugosities 70, or to the micro-rugosities 72 for an article to be considered micro-conformable. FIG. 6 can be contrasted with FIG. 7 which shows an example of a surface covering material 17 that achieves relatively poor conformability with the underlying dry wall material.

It has been found that consumers do not prefer articles which are not able to deliver micro-conformability as described above. Consumers believe that articles that are not able to deliver this level of conformability look more like a large piece of adhesive tape on the wall, rather than a dry paint. Typically, for a previously painted drywall surface, the surface texture resulting from roller paint coating has a roughness value (Ra) of 5-10 microns with a maximum peak to valley heights of 30-50 microns and spacing of major peaks of several millimeters. If an applied surface covering component bridges these peaks, it changes the overall appearance of the wall texture in a negative way. This is the case even if the surface covering component 17 has an inner surface 17A (but not an outer surface 17B) that conforms to the rugosities 70 such as is shown in dashed lines between the second and third rugosities 70 in FIG. 17A. Such a structure having an inner surface 17A that achieves micro-conformability, but an outer surface 17B that does not, would be suitable for a film applied to an automobile body to provide a smooth exterior appearance, but would not provide the desired paint-like appearance for interior drywall surfaces.

A test procedure for measuring conformability and micro-conformability is as follows. Sample sheets of the article measuring 4 feet (1.2 m)×1 foot (0.3 m) are applied to the surface of a piece of primed and painted U.S. dry wall material. The sample sheets are then visually assessed by ten panelists and graded numerically against the following scale. In the following table, in grading uniformity of the conformability, the term “patches” refers to areas of the article which are substantially free of texture from the underlying dry wall material.

| Rating | | |
|---|---|---|
| Scale | Micro-Conformability | Uniformity |
| 0 | Totally floating/detached | Very well defined patches |
| 2 | Slight texture | Large patches |
| 4 | Texture, but different than | Small patches |
| | wall | |
| 6 | Can clearly see wall texture | Some patchiness |
| 8 | Very close to wall texture | Very slight patchiness |
| 10 | Perfectly following wall | Completely uniform across |
| | texture | sheet |

The conformability and micro-conformability are preferably exhibited at room temperature as defined above. It is desirable that the article have an average micro-conformability score of at least 6. It may also be desirable that the article have an average uniformity score of at least 6. Without wishing to be bound by any particular theory, the properties which are believed to provide the surface covering component with the desired conformability are its flexibility as defined by its bending stiffness and rigidity, along with at least the minimal level of extensibility described above. If the surface covering component has these properties, it may exhibit the desired level of conformity, even if it is provided with a relatively stiff and relatively inextensible structural layer.

Conformability can also be expressed in terms of sensory data that measures the extent to which the surface covering component 17 looks and feels like paint on a surface such as a wall.

A test procedure for measuring the extent to which the multi-layer dry color laminate looks and feels like paint on a surface is as follows. Two sheets of the article to be tested are applied to the surface of a piece of primed and painted U.S. drywall material. The sheets are applied in the manner directed by the manufacturer, and are applied so that any seam formed by the application of the sheets runs down the center of the drywall material. The drywall material is cut into a panel which measures 1 foot (0.3 m)×1 foot (0.3 m), keeping any seam in the center of the panel. Four comparison samples are prepared on surfaces of similar primed (but not initially painted) U.S. drywall material panels. The comparison samples comprise: (1) a panel painted with interior wall paint having a satin gloss level; (2) a panel painted with interior semi-gloss wall paint; (3) a panel painted with a faux finish using a metallic paint applied with a sponge; and (4) a panel painted with a faux finish using a faux combing tool. The samples are then assessed by twenty panelists. For the “Looks Like Paint” assessment, the samples are compared visually. For the “Feels Like Paint” assessment, the panelists are blindfolded, and the panelists compare the samples by feeling the surfaces of the same. The samples are then graded numerically against the following scale.

| Rating | | |
|---|---|---|
| Scale | Looks Like Paint | Feels Like Paint |
| 1 | does not look like paint at all | does not feel like paint at all |
| 2 | slightly looks like paint | slightly feels like paint |
| 3 | somewhat looks like paint | somewhat feels like paint |
| 4 | very much looks like paint | very much feels like paint |
| 5 | extremely looks like paint | extremely feels like paint |

The material being tested against the comparison samples preferably achieves a score of 3 or better on at least one of the “Feels Like Paint” and “Looks like Paint” scales. In another way of evaluating the extent to which the material being tested feels or looks like paint, the material preferably scores within 1 point, more preferably within ½ point of the painted surfaces on the “Feels Like Paint” and “Looks Like Paint” scale.

One possible use of the multi-layer dry color laminate is as a surface covering for interior architectural surfaces. Therefore, it is desirable for the surface covering component to exhibit dimensional stability. That is, the surface covering component should be substantially insensitive to changes in heat or moisture and should not substantially expand or contract after application on the wall. Dimensional instability may be exhibited as the surface covering component lifting up from corners, expansion or contraction at seams or overlapped areas, or shrinkage in the z-direction. Such dimensional instability can lead to an undesirable appearance and detract from the desired virtually seamless, paint-like appearance of the applied laminate. The inclusion of a structural layer with a relatively high modulus and low moisture sensitivity can provide the surface covering component with dimensional stability while maintaining other desirable features such as micro conformability and rigidity.

Gloss

Gloss for the articles described herein, is measured by specular reflectance of a beam of light at angles of 60° and 85°. Typically, the specular reflectance for the surface covering component is less than, or less than or equal to, any one of the following: about 60, 50, 40, 30, 20, 10, or 5 gloss units at 60°. A lower limit may be about 1 gloss unit at 60°. The specular reflectance for the surface covering component may be less than, or less than or equal to, any one of the following: about 60, 50, 40, 30, or 20 gloss units at 85°.

In one embodiment, the surface covering component has a specular reflectance of between about 1-6, alternatively between about 3-6 gloss units, or alternatively less than 5 gloss units at 60°. Such an embodiment may have a specular reflectance at 85° of: between about 3-60 gloss units, alternatively between about 3-50 gloss units, alternatively less than 20 gloss units, alternatively, between about 3-20 gloss units, alternatively, between about 10-20 gloss units, or alternatively between about 12-15 gloss units. In one embodiment, a non-filled topcoat can be embossed to produce a surface covering component with a specular reflectance of 2 gloss units at 60° and 5 gloss units at 85°.

One of ordinary skill in the art will appreciate the difference between such finishes and high-gloss finishes such as are employed in, for example, the automotive industry. Specular reflectance may be measured using the test method described in General Motors Test Specification TM-204-A. The Byk-Mallinckrodt “multi-gloss” or “single gloss” gloss meters can be used for measuring specular gloss of the finished surface. Those gloss meters give values equivalent to those obtained from ASTM Method D-523-57. Further details on the specular reflectance measurements are disclosed in U.S. Patent Application Publication No. US 2004/0200564 A1.

Discoloration Barrier Properties

The structural layer, in some embodiments, may provide discoloration prevention properties as described in U.S. Patent Application Publication No. US 2005/0196607 A1. In certain embodiments, the structural layer provides a barrier to discoloration-causing pigments characterized by producing a color shift of no more than 0.40 Δb* C.I.E. color units at 60° C. for at least 400 hours.

Force Balance

The components of the dry color laminate may be provided with differential release properties between the layers thereof as described in U.S. Patent Application Publication No. US 2005/0003129 A1. However, in the case of the multi-layer dry color laminate described herein, the carrier structure release force at normal removal rates (from 10-1000 inches/min (25-2,500 cm/min.), or 12-300 inches/min (30-760 cm/min.)) may be lower than the roll unwind force, provided that the force to initiate carrier structure release is sufficiently high to prevent premature delamination during processing or application to the wall. Further, it is desired that the force to initiate carrier structure release is lower than the adhesion force of the product to the wall, so that the carrier structure may be removed without lifting the applied product.

It is further described in U.S. Patent Application Publication No. 2006/0051571 A1, that the product adhesive forces must balance during application and repositioning of the product on the wall. An advantage of the current product construction is that the product applied to the wall, after removal of the carrier structure, has high modulus and low extensibility. Thus, when a second film is applied at an overlap and needs to be repositioned, the first film has a low tendency to stretch, and consequently the second film can be removed without the first film deforming and lifting from the wall.

Water Vapor Transmission Rate

The articles and methods may be employed to provide a porous surface covering component which allows air to escape as the article is applied to a surface, thereby avoiding bubbles and/or wrinkles from appearing on a covered surface. In certain embodiments, the surface covering component is microporous and therefore allows moisture to escape rather than accumulating between the applied article and a surface to which it is applied. For example, the surface covering components provided by the articles and methods described herein may, in certain cases, exhibit a water vapor transmission rate (WVTR) of greater than about 0.1 g-μm/cm²/24 hrs, or greater than about 1 g-μm/cm²/24 hrs, or greater than about 4 g-μm/cm²/24 hrs, at 100% relative humidity and 40° C., as measured according to ASTM F1249-90. The desired WVTR may be provided through the use of materials which inherently allow water vapor transmission and/or by providing pores, perforations, orifices or the like in the articles, either on a micro or macro scale.

The laminates described herein, and components thereof, may also be formed of any of the materials, or be provided with any of the properties, components, or have any of the layer arrangements described in the following patent publications: U.S. Patent Application Publication No. US 2003/0134114 A1; U.S. Patent Application Publication No. US 2004/0076788 A1; U.S. Patent Application Publication No. US 2004/0200564 A1; U.S. Patent Application Publication No. US 2006/0046027 A1, US 2006/0046028 A1, and US 2006/0046083 A1; U.S. Patent Application Publication No. US 2006/0051571 A1; U.S. Patent Application Publication No. US 2004/0253421 A1; U.S. Patent Application Publication No. US 2005/0003129 A1; and, U.S. Patent Application Publication No. US 2005/0196607 A1 on Sep. 8, 2005.

Methods of Applying Color to a Surface

The multi-layer dry color laminate 10 may be used by unrolling it from the roll (that is, if it is in roll form). In one embodiment, the multi-layer laminate is simultaneously unrolled and applied to the substrate surface. The multi-layer laminate is placed over the substrate with the adhesive 14 in contact with the substrate 20. The multi-layer laminate 10 is particularly suited for applying to a wall under room temperature conditions. Pressure is applied, with repositioning if necessary, until the multi-layer laminate is adhered to the surface. The carrier structure 16 is then peeled off the front face of the surface covering component 17, leaving the surface covering component 17 adhered to the substrate by the adhesive 14. The carrier structure 16 can be peeled off the front face of the surface covering component 17 in any suitable manner, including using a tape that adheres to the carrier structure 16 to assist in removing the same. The surface covering component 17 can be smoothed down on the substrate surface by applied pressure after the carrier structure 16 is removed.

The multi-layer laminate may be applied to a surface by hand, or with the use of a simple applicator, for example a wall paper roller, and/or dispenser, or other tool. Tools suitable for applying the articles are described in: U.S. Pat. No. 6,808,586 B1 issued to Steinhardt; U.S. Patent Application Publication No. US 2005/0092420 A1; and, U.S. patent application Ser. No. 11/413,765, filed Apr. 28, 2006. Any pressure required for adhesion of the articles may be applied by hand or with a tool. Such pressure may be applied in a single pass or by two or more passes over the article.

Methods of Making the Articles

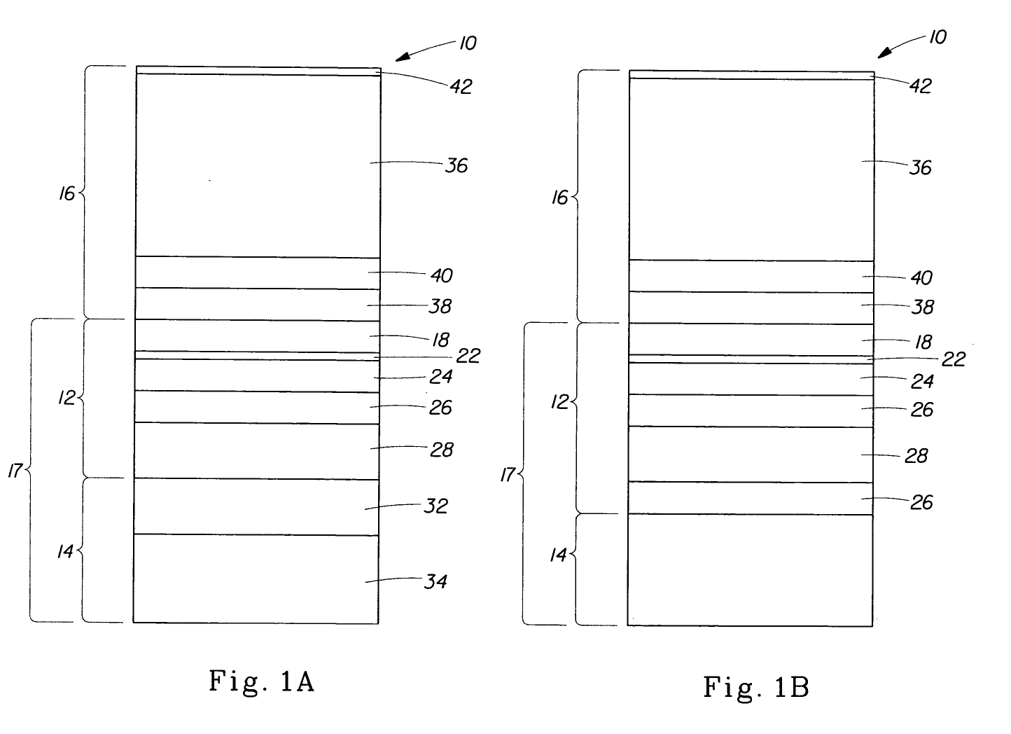

FIG. 2 is a simplified schematic of one non-limiting embodiment of a method of manufacture of the dry color component 12.

Processes for making the dry color component can use any suitable inks and print cylinders. Suitable inks include, but are not limited to water-based inks, solvent-based inks, UV curable inks, heat set/thermal cure inks or other ink systems suitable to continuous tone printing. Suitable printing processes include, but are not limited to: flexographic, lithographic, electrostatic, ink jet, gravure, or other processes suitable to meet the objectives of the printing process.

The process shown in FIG. 2 is generally known as a direct rotogravure printing process. The process utilizes a fluid organic solvent-based ink and a chrome coated mechanically engraved or chemically etched print cylinder, suitable to the ink being printed with respect to thickness, coverage, rheology, color and resolution. The print cylinder that deposits the ink from a printing ink reservoir to the structural layer, which serves as the print substrate. Alternative gravure print cylinders may be ceramic coated, laser-engraved, or may use other alternative imaging and surfacing technologies.

In one embodiment, the ink has a viscosity in the range of 16-28 seconds as measured by a #2 Zahn cup test. The Zahn cup is widely used in the coating industry to measure viscosities of liquids. It is basically a stainless steel dip tube with a precise orifice drilled in the bottom. The user times how long it takes for fluid to empty out of the cup. This can be translated to Centipoise, or more commonly is expressed in terms of “seconds”. There are different number cups depending on viscosity ranges, #2 is a typical one. There is an ASTM standard method for the measurement. It is ASTM D 4212 Test Method for Viscosity by Dip-Type Viscosity Cups.

The rotogravure process used for making the dry color component 12 involves transporting a continuous web of PET film from an unwind stand U, to a rewind stand R under proper tension and tracking to position the web properly with respect to the print units in each of the eight print stations shown in FIG. 2. The print system comprises a print head PH which prints the desired image onto the substrate and an oven which dries the ink to the desired solvent retention level. The capacity of the drying oven is related to the desired solvent retention level, the constituency of the blend of solvents used in the ink and the speed at which the process is to be run.

In its preferred embodiments, a number of print colors are used to assemble the dry color component. Generally, the first two print units, units 1 and 2, are used to print white opacifying ink layers in the range of 4 grams per square meter. In an alternative embodiment designed for achieving the color and whiteness values for very light colors, three separate layers of opacifying ink are used in succession in print units 1, 2 and 3. Additional layers of opacifying ink may be used though depending on the finished color, two or three opacifying ink layers are sufficient to achieve the desired opacity of >99.3% in combination with the opacity of the adhesive added in subsequent processes.

The two or three opacifying ink layers may be printed on the same side or on opposing sides of the PET film. Surface treatments may be used to ensure the desired ink adhesion irrespective of the surface on which the printing occurs.

After the appropriate number of opacifying layers are printed, the web is further printed in print units 4 and 5 with ink layers for the specific color appearance desired. The print color layers may include a matting agent or other additives to ensure proper color and ink performance properties.

After the print color layers are dried in their respective ovens, a halftone or benday print structure is used to create a visually non-repeating graphic of suitable color and detail to meet intended use of the surface covering component. This graphic requires at least two separate print cylinder engravings mounted in print heads 6 and 7. Additional print heads may be used in which case the rotogravure press would be equipped with more than eight print heads.

Finally, a matte topcoating is printed over the opacifying and color layers in print unit 8. This topcoating is designed to meet the requirements of gloss, stain resistance, scratch resistance and other physical properties needed to meet the product's intended use.

The foregoing process may provide better control of print quality (sharper, more consistent print quality) using the substantially smooth surface of the structural layer in comparison to prior structures which were printed in reverse order upon a textured topcoat layer. One advantage of this construction is that gloss and release are separated so gloss can be made much flatter (low gloss) and there will still be good release of the carrier structure from the topcoat.

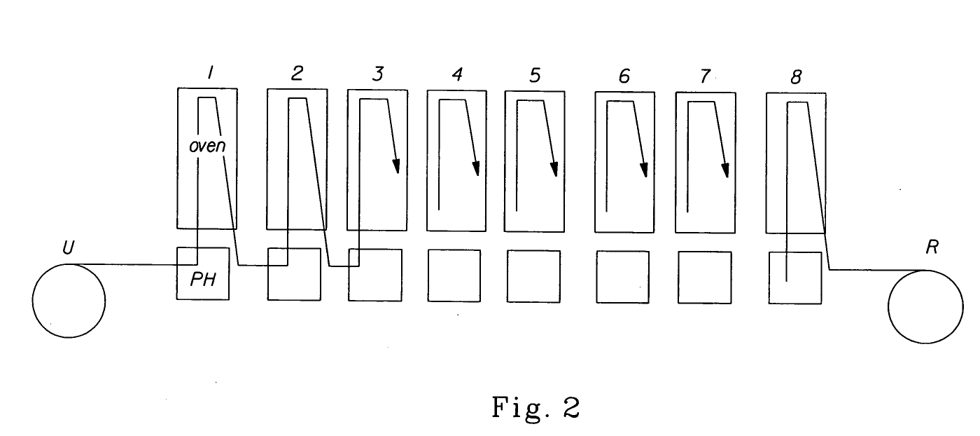

As shown in FIG. 3, the carrier structure 16 can be formed separately with an adhesive release coat 42 on one side (for engaging the pressure sensitive adhesive layer when the laminate is in roll form) and a release surface 38 on the surface that will face the topcoat 18. The carrier structure 16 can then be releasably joined to the topcoat 18. The pressure sensitive adhesive layer 14 can also be formed separately and then joined to the structural layer 28. The components may, as shown in FIG. 3, be joined in order with either step B following step A; or, with step A following step B.

The articles and methods described herein offer manufacturing benefits. Since the layers are typically thin printed layers instead of thick reverse roll coated layers, line speeds may be increased. Patterns and colors can be easily changed by changing the cylinders or inks in the appropriate print station. In addition, since the carrier structure 16, the dry color component 12, and adhesive 14 may be prepared separately, additional flexibility in combining the separate elements may be achieved by maintaining stocks of each element and joining them to create various different finished articles using methods such as lamination.

### EXAMPLES

The first example is a base system which has darker colors in the color layer(s) and uses two tinted opacifying layers and a single layer of gray adhesive. The second example is system which has lighter colors in the color layer(s) that includes a third layer of the white opacifying coating and a dual layer PSA system.

### Example 1

A substrate film comprising Toray PA-10 9 μm biaxially oriented PET film is obtained from Toray Company of North Kingston, R.I., U.S.A. This film has a coextruded amorphous polyester forming the first surface thereof. Printing or coating is done on the amorphous polyester surface. This substrate film is coated via a gravure process described above utilizing seven separate print stations. The coatings are applied to the first surface of the substrate film in the following sequence: opacifying layer 1, opacifying layer 2, color layer 1, color layer 2, grain pattern layer 1, grain pattern layer 2, and topcoat layer 1. The substrate film with the seven applied coatings comprises the printed substrate. The first surface of the printed substrate is the topcoat layer and the second surface of the printed substrate is the second surface of the PET substrate film.

Opacifying layers are sequentially gravure printed onto the first surface of the PET substrate film. Each of the two opacifying layers is coated at a 4 gram per square meter dry weight basis. The opacifying layers comprise Product No. FSBH0U4DA obtained from Siegwerk, U.S.A. of Des Moines, Iowa. This gray coating comprises Siegwerk FSBA9U0CW modified F11 NA white and FFLH1M46 black tint base. The NA coatings are preferred as they do not contain larger particle silica matting agents or polyethylene waxes which may effect coating quality of subsequent layers. The coating comprises polyurethane, TiO₂, silica, pigment, and a solvent system comprising butyl acetate, ethyl alcohol, isopropyl alcohol, n-propyl acetate, and n-propyl alcohol. Tinting of the opacity layer may be adjusted as desired. The color coat layers are printed sequentially onto the surface of opacifying layer 2. Each of the two color coat layers are coated at a 2 gram per square meter dry weight basis. The color coat layers comprise the Siegwerk Ink modified SEALTECH R38™ CLASSICAL BISQUE™ coating, Product No. FELB4A2LU, and comprises polyurethane, nitrocellulose, silica, pigment, and a solvent system comprising isopropyl alcohol, n-propyl acetate, and n-propyl alcohol.

The grain pattern layers are sequentially printed onto the surface of color coat layer 2. Each of the two grain pattern layers are printed (discontinuous coating) at a coat weight average of less than 1 gram per square meter dry weight basis. The grain pattern layers can comprise versions of the Siegwerk Ink modified SEALTECH R38™ coating described above, Siegwerk Product No. FELH3U8BY 536 Gray Grain 1, and Product No. FELQ3U9BY Tan Dot 2.

The topcoat layer is printed onto the surface of grain pattern layer 2. The topcoat is printed at a 2 gram per square meter dry weight basis to form a continuous layer of a thermoplastic acrylic resin with silica particles dispersed therein. The topcoat layer comprises Siegwerk Ink Product No. FSBM0A0MT which comprises ELVACITE® 2042 (product of Lucite International, poly (ethyl methacrylate)), Degussa TS-100 Silica, n-propyl acetate, and ethyl acetate. Silica can be added or omitted from any or all of the color and opacifying layers to achieve desired coating quality.

A pigmented pressure sensitive adhesive layer is then applied to a polyester carrier at a coat weight of 13 to 20 grams per square meter. The dry film thickness of the PSA is from about 0.45 to 0.70 mil. The PSA is applied to the second surface of the aforementioned printed substrate film by transfer lamination; corona treatment of the second surface may be used to increase adhesion of the PSA to the untreated polyester substrate. The PSA is available from Avery Dennison Corporation under product number S-3526 and the formulation for the PSA is as follows (with numerical values in parts per hundred weight):

| Component | Parts |
|---|---|
| S-3506 (product of Avery Dennison, Performance | 96.0 |
| Polymers, a cross-linked copolymer emulsion of butyl | |
| acrylate and 2-ethyl hexyl acrylate) | |
| UCD 110GE (white TiO₂ pigment dispersion from Rohm | 3.7 |
| and Haas) | |
| UCD 1507E (carbon black pigment dispersion from | 0.3 |
| Rohm and Haas) | |

A highly polar release coating is applied to the first surface of the printed substrate film subsequent to the lamination of the PSA and transfer liner to the second surface of said printed substrate film. The release coating is prepared as a copolymer of 2-hydroxyethyl methacrylate and 4-hydroxybutyl acrylate in an ethanol/water solution from the following components:

| Component | Amount |
|---|---|
| 2-hydroxyethyl methacrylate | 200 grams |
| 4-hydroxybutyl acrylate | 100 grams |
| ethanol | 400 grams |
| deionized water | 260 grams |

The release coat materials are polymerized by mixing in a reaction vessel and heating at a temperature of 80° C. Small amounts of initiators comprising deionized water and sodium persulfate are mixed with the contents at different time intervals to prepare a polymeric film similar to the process described in Example 26 of U.S. Pat. No. 6,653,427 to Holguin. After polymerization, the pH is adjusted to neutral. The highly polar coating is applied to the topcoat layer through a die coating operation followed by drying to remove the solvent system. The highly polar release coating is applied to the first surface of the printed substrate film at a 3 gram per square meter dry basis weight.

A PET carrier sheet is coated on the first side with a silicone release coating. This corresponds to the adhesive release coat layer described above. The thickness of the silicone coated liner is 0.92 mil (23.4 μm) and comprises Mitsubishi 92 gauge 2SLK.

A pressure sensitive adhesive is coated onto the second side of the PET carrier sheet via die coating at a coat weight of 5 grams per square meter. The PSA coated carrier sheet is then laminated onto the highly polar release coating previously applied onto the first surface of the printed substrate film. The PSA is available from Avery Dennison Corporation under product number S-8860 and is a solvent-based adhesive.

### Example 2

In Example 2, an additional opacifying layer is included, and two pigmented layers of pressure sensitive adhesive are used. In Example 2, the process described in Example 1 is followed, with the following exceptions. A substrate film comprising SKC SP-91 9 μm clear PET is coated via a gravure process described above utilizing eight separate print stations. The coatings are applied to the first surface of the substrate film in the following sequence: opacifying layer 1, opacifying layer 2, opacifying layer 3, color layer 1, color layer 2, grain pattern layer 1, grain pattern layer 2, and topcoat layer 1. The substrate film with the 8 applied coatings comprises the printed substrate. The color coat layers are printed sequentially onto the surface of opacifying layer 3.

In this embodiment, two pigmented pressure sensitive adhesive layers are then applied to the polyester carrier via a dual die coating process to a carrier at a total coat weight of 30 grams per square meter. The two layers consist of a highly pigmented white PSA formulation and a gray pigmented S-3526 PSA described in Example 1. The dual layer PSA coating has a ratio of white PSA to gray PSA of 1.5:1 on a coat weight basis. The dry film thickness of the dual layer PSA is from about 0.6 to 0.76 mil. The white PSA side of the dual layer PSA is applied to the second surface of the printed substrate film by transfer lamination. The formulation for the white PSA is as follows (with numerical values in parts per hundred dry weight):

| Component | Parts |
|---|---|
| S-3506 (product of Avery Dennison, Performance | 65 |
| Polymers, a cross-linked copolymer emulsion of butyl | |
| acrylate and 2-ethyl hexyl acrylate) | |
| UCD 110GE (white TiO₂ pigment dispersion from Rohm | 35 |
| and Haas) | |

The highly polar release coat system and the PET carrier sheet are applied to the printed substrate as in Example 1.

The dry film thickness of the components of the laminate in Examples 1 and 2 are as follows:

| | Dry Film Thickness mils (microns) | |
|---|---|---|
| Component | Example 1 | Example 2 |
| Carrier sheet | 0.9 mils (23 μm) | 0.9 mils (23 μm) |
| Carrier sheet adhesive | 0.2 (5) | 0.2 (5) |
| Release coating | 0.1 (2.5) | 0.1 (2.5) |
| Topcoat | 0.1 (2.5) | 0.1 (2.5) |
| Patterns and Color layers | 0.15 (3.8) | 0.15 (3.8) |
| Opacifying layers (combined) | 0.2 (5) | 0.3 (7.6) |
| Structural layer | 0.35 (9) | 0.35 (9) |
| Pressure sensitive adhesive | 0.65 (16.5) | 0.9 (23) |
| Thickness of Surface Covering | 1.45 (36.8) | 1.8 (46) |
| Component | | |
| Total Thickness | 2.65 (67) | 3.0 (76) |

### Examples 3-12

Examples 3-12 were prepared in a manner similar to either Example 1 or 2, and have components with dry film thicknesses and rigidity values set forth in the following table.

| | Dry Film Thickness (microns) | | | | | | | | | |
|---|---|---|---|---|---|---|---|---|---|---|
| Component | Ex. 3 | Ex. 4 | Ex. 5 | Ex. 6 | Ex. 7 | Ex. 8 | Ex. 9 | Ex. 10 | Ex. 11 | Ex. 12 |
| Carrier sheet | 26 | 26 | 25.5 | 25.5 | 25 | 25 | 25 | 26 | 25 | 25.5 |
| Carrier sheet adhesive | 4 | 4.5 | 4 | 4 | 5.4 | 4.7 | 4.1 | 3.3 | 3.3 | 3 |
| Release coating | 2.68 | 2.85 | 2.75 | 2.85 | 3.8 | 3.6 | 3.1 | 2.5 | 2.7 | 3 |
| Topcoat | 0.8 | 0.8 | 0.7 | 0.8 | 0.8 | 0.7 | 0.9 | 0.6 | 0.6 | 0.5 |
| Patterns | 0.5 | 0.5 | <0.5 | 0.3 | 0.5 | 0.5 | 0.7 | 0.3 | 0.5 | 0.3 |
| Color layers | 2.3 | 2.3 | 2.3 | 1.7 | 2.8 | 2 | 2.7 | 2.4 | 2.5 | 3.3 |
| Opacifying layers (combined) | 2.7 | 3.5 | 2.5 | 3.3 | 5 | 3.9 | 4.5 | 3.5 | 5 | 3 |
| Structural layer | 8.5 | 9 | 9.5 | 9.3 | 9.1 | 9.2 | 8.9 | 9 | 8.4 | 8.4 |
| Pressure sensitive adhesive | 18 | 17 | 18 | 17 | | | | 16.6 | 13.5¹ | 15 |
| | | | | | | | | | 10.7² | |
| Thickness of Surface Covering | 32.8 | 33.1 | <33.5 | 32.4 | — | — | — | 32.4 | 41.2 | 30.5 |
| Component | | | | | | | | | | |
| Total Thickness | 65.5 | 66.4 | <65.8 | 64.8 | — | — | — | 64.2 | 72.2 | 62 |
| Rigidity with Carrier (g/cm) | 8.5 | 8.8 | 8.6 | 8.8 | 10 | 9.57 | 9.98 | 9.23 | 10.2 | 9.3 |
| Rigidity without Carrier (g/cm) | 0.33 | 0.38 | 0.37 | 0.38 | 0.43 | 0.4 | 0.44 | 0.52 | 0.65 | 0.43 |

¹White adhesive layer
²Gray adhesive layer

### Examples 13-15

The dry color component is prepared in the same manner as in Example 1. In this example, the release coating comprises a heat-activated polymer blend.

Separate from forming the dry color component, a PET carrier sheet is coated on the first side with a silicone release coating. This corresponds to the adhesive release coat layer described above. The thickness of the silicone coated liner is 0.75 mil (19.0 μm) and comprises Mitsubishi 75 gauge 2SLK film.

For Example 13, a modified polyethyleneimine dispersion (Mica A-131-X from Mica Corporation, Shelton, Conn., USA) is gravure coated at 0.02 to 0.06 gram per square meter onto the non-silicone side of the PET as a primer to improve adhesion. The non-silicone side of the PET may be corona treated prior to application of the primer. Typical treatment is 3 to 4 kW with a coating speed of 400-600 fpm and film width between 34″ and 66″. Alternately, an EVA tie layer comprising Elvax 260 with 28% vinyl acetate content may be used instead of the primer above. A heat activating polymer is then extrusion coated over the primer or tie layer. Extrusion melt temperatures for plastomer are 550 F-650 F with preferred temperatures around 600-615 F. The heat activating polymer is a blend of 50% Chevron Philips MARFLEX™ 1017, a low density polyethylene with 50% ExxonMobil EXACT™ Plastomer 3139, an ethylene hexene copolymer. The extrusion coating air gap can effect the final carrier release force due to the amount of thermal oxidation. An optimum release force of 60-70 g/2 inch was obtained by setting an air gap of 5 inches measured between the die lip and the nip between the rubber roll and chill roll in the extrusion coating process. By properly adjusting the amount of air gap and oxidation, a pure blend of MARFLEX™ 1017 can be used to obtain this same range of release force.

For Example 14, a slightly polar heat activating polymer with 50-96% of Dowlex 2045 LLDPE and the balance of Dupont ELVALOY™ 1820 C (ethylene methyl acrylate with 20% methyl acrylate) used as the heat activating polymer. The total coating thickness of the heat activating layer is about 0.5 mil.

For Example 15, a tie layer of 26% Vinyl Acetate content EVA is coextruded with an EVA copolymer containing 95-98% LDPE or LLDPE with 2%-5% of Vinyl Acetate onto the second side of the PET carrier sheet. Suitable materials include MARFLEX™ 1017 LDPE from Chevron Phillips, The Woodland, Tex., USA, Dowlex 2045 or 2035 LLDPE from Dow Chemical, Midland, Mich., USA, Elvax 750 (9% Vinyl Acetate by weight) or Elvax 550 (15% Vinyl Acetate by weight) from Dupont, Wilmington, Del., USA. A preferred mode is to blend 83.3% of Dowlex 2035 with 16.7% of Elvax 550 to make a blend with 2.5% VA content.

The carrier sheet made above is then heat-laminated to the dry color component at a temperature of about 275° F. to 325° F. (135° C. to 163° C.). When one component is heat-laminated to another component, a bond is formed where at least one of the components is at least partially melted (or fused) onto the surface of the other component. During lamination, the nip is set with positive stops. The pressure used is sufficient to prevent the rolls from separating from this fixed nip point. The use of the positive nip means the pressure is based on the composition and deflection of the rubber roll by the heated steel roll. Representative processing conditions use a deflection of 10 to 20 thousandths of an inch and a 65 or 85 durometer rubber roll. Pressures are approximately 25-90 psi but may be adjusted as needed to control release force and adhesion. In addition, one skilled in the art will recognize the ability to control the bonding quality of the carrier sheet by adjusting the coating composition of the carrier film, laminating drum temperature, amount of wrap on the heated drum prior to the nip, amount of wrap on the heated drum after the nip, or amount of deflection of the heated drum into the rubber roll.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-layer microconformable laminate for applying a layer of color to an architectural surface, the laminate comprising:
a dry color component having an outer surface, said dry color component comprising:
a flexible structural layer comprising a pre-formed axially oriented semi crystalline polymeric film which is substantially non-elastomeric at room temperatures, the structural layer having a first surface and a second surface;
a flexible dry color element comprising one or more color layers and/or print coat layers overlying the first surface of the structural layer, the one or more color layers comprising a resinous binder and a pigment;
a pressure sensitive adhesive layer overlying the second surface of the structural layer for adhering the laminate to an architectural surface;
a flexible temporary carrier overlying the outer surface of the dry color component, the carrier being releasable from the dry color component at room temperatures for exposing an outer surface of the dry color component when the carrier is peeled away from the dry color component, and
a release layer between the carrier and the color component, wherein the release layer separates the carrier from the outer surface of the dry color component when the carrier is peeled away from the outer surface of the dry color component;
wherein the dry color component and the adhesive layer have a combined thickness of less than about 3 mils; the dry color component and the adhesive layer together have an opacity index of about 0.95 or higher; the structural layer has a thickness of less than about 0.60 mils; and the laminate has a bending stiffness of greater than or equal to about 10 milli Newton (mN) and less than or equal to about 20 mN.

2. The laminate according to claim 1 in which the release layer is separable from the outer surface of the dry color component substantially in the absence of affecting optical surface properties of the exposed outer surface.

3. The laminate according to claim 1 in which the structural layer is selected from the group consisting of polyester, PET, and polyamide.

4. The laminate according to claim 1 in which the release layer comprises a heat-activated release coat bonded to the carrier, and at least partially melted on the outer surface of the dry color component.

5. The laminate according to claim 1 in which the release layer is coated on the outer surface of the dry color component.

6. The laminate according to claim 1 in which the release coat comprises a polymer blend that provides essentially tack-free adhesion to the outer surface of the dry color component.

7. The laminate according to claim 1 in which the release layer comprises one or more of the following: polyethylene, vinyl acetate, ethylene vinyl acetate, ethylene hexene, ethylene octane, ethylene methyl acrylate, polyolefin or mixtures thereof.

8. The laminate according to claim 6 in which the release layer includes a tie layer bonding the release coat to the carrier in one of the following manners: (a) the release coat and the tie layer are coextruded; (b) the release coat is extruded; and (c) the release coat is extruded on a tie layer.

9. The laminate according to claim 1 in which the dry color component includes a pigmented opacifying layer between the structural layer and one or more of the color and/or print coat layers.

10. The laminate according to claim 9 having side edges wherein the opacifying layer hue and color value are adjusted to minimize color differences between the opacifying layer and said one or more color and/or print coat layers to reduce visual perception of the edges of the laminate.

11. The laminate according to claim 1 wherein there is an initiation force to initiate the removal of the release layer and a subsequent release force to complete the removal of the release layer, and the initiation release force to remove the release layer is higher than the subsequent release force needed to remove the release layer, and wherein the release layer is sufficiently adhered to the overlying carrier sheet to resist delamination of the release layer from the carrier sheet.

12. The laminate of claim 1 wherein said carrier elongates less than 50% at temperatures of from about 40° F. (4° C.) to less than 104° F. (40° C.).

13. The laminate according to claim 1 in which the structural layer in combination with the dry color component and the pressure sensitive adhesive layer has: (a) a tensile modulus of at least 300 MPa, (b) an extensibility of from about 0.1% to less than about 5%, and/or (c) a rigidity without the carrier of less than or equal to about 1 gm/cm.

14. The laminate according to claim 1 having a rigidity with the carrier of greater than 4 gm/cm.

15. The laminate according to claim 1 having a micro-conformability score of at least 6.

16. A laminate according to claim 1 which achieves a score of 3 or better on the “Feels Like Paint” scale.

17. A multi-layer microconformable laminate for applying a layer of color to an architectural surface, the laminate comprising:
(a) a flexible surface covering component having a thickness of less than about 3.3 mils, said surface covering component comprising:
(1) a structural layer comprising a pre-formed self-supporting axially oriented polymeric film having a thickness from about 4.5 to about 12 microns and which resists migration of discoloration-causing pigments or dyes from a painted architectural surface through the structural layer, said structural layer being substantially non-elastomeric at room temperature;
(2) a flexible dry color element comprising one or more color layers overlying the first surface of the structural layer, the one or more color layers comprising a resinous binder and a pigment, and a substantially transparent top coat layer overlying said one or more color layers; and
(3) a pressure sensitive adhesive layer on a side of the structural layer opposite from the dry color element for adhering the surface covering component to an architectural surface; and
(b) a flexible temporary carrier film overlying the top coat surface of the dry color element, said carrier film having a thickness of between about 0.5 and 2 mils, and comprising a carrier and a substantially tack-free dry release layer bonded to the carrier and in contact with the top coat layer along an interface having a level of adhesion sufficient for the carrier to support the surface covering component and by an absence of interaction between the release layer and the top coat so that exterior optical surface properties of the top coat along the interface are substantially unaffected by previous contact with the release coat when the temporary carrier film is peeled away from the surface covering component which in turn has been adhered to an architectural surface via the pressure sensitive adhesive layer,
wherein the laminate has a bending stiffness of greater than or equal to about 10 milli Newton (mN) and less than or equal to about 20 mN.

18. The laminate according to claim 17 in which the release layer comprises one or more of the following: polyhydroxyethylmethacrylate, polyvinylpyrrolidone, and polyvinylacetate polymers and copolymers, or mixtures thereof.

19. The laminate according to claim 17 in which the release layer material is one of the following:
(a) a hydrophilic material having a polarity in excess of the polarity of the top coat material,
(b) a polymeric material which has been dispersed in a solvent and dried in contact with the top coat layer without the solvent having dissolved the top coat layer,
(c) a substantially solvent-free polymeric material adhered to the top coat at a lower adhesion force than the adhesion of the release layer to the temporary carrier, or
(d) a material having a lower polarity than the polarity of the top coat material.

20. The laminate according to claim 17 in which the pressure-sensitive adhesive layer has a first portion containing a greater amount of pigment than a second portion thereof, the second portion being for adhering the laminate to the architectural surface, the dry color component including an opacifying coat underlying said one or more color layers, said first portion of the pressure sensitive adhesive and said opacifying coat providing a majority of the total opacity index of the layer of color applied to the architectural surface.
